(19) United States
(12) Patent Application Publication
(10) Pub. No.: US 2026/0223112 A1
(43) Pub. Date: Jul. 30, 2026

(54) COMMUNICATION METHOD AND COMMUNICATION APPARATUS

(71) Applicant: HUAWEI TECHNOLOGIES CO., LTD., Shenzhen (CN)

(72) Inventors: Ruonan Yang, Shenzhen (CN); Ying Chen, Hangzhou (CN); Jun Wang, Hangzhou (CN)

(21) Appl. No.: 19/629,151

(22) Filed: Mar. 26, 2026

Related U.S. Application Data
(63) Continuation of application No. PCT/CN2024/121019, filed on Sep. 25, 2024.

(30) Foreign Application Priority Data
Sep. 27, 2023 (CN) 202311281440.4

(51) Int. Cl. H04W 72/1273; H04L 1/1812

(52) U.S. Cl. CPC H04W 72/1273; H04L 1/1812

(57) ABSTRACT

This disclosure provides a communication method and a communication apparatus. The method includes: A terminal device receives first control information and first data from a network device, where the first control information is used to schedule the first data, the first control information includes second information and first information, the second information and the first information indicate that the first data is newly transmitted data or retransmitted data, and indication manners of the second information and the first information are different. The terminal device processes the first data based on the first control information.

### CROSS-REFERENCE TO RELATED APPLICATIONS

This application is a continuation of International Application No. PCT/CN2024/121019, filed on Sep. 25, 2024, which claims priority to Chinese Patent Application No. 202311281440.4, filed on Sep. 27 2023 The disclosures of the aforementioned applications are hereby incorporated by reference in their entireties.

### TECHNICAL FIELD

This disclosure relates to the communication field, and more specifically, to a communication method and a communication apparatus.

### BACKGROUND

A non-terrestrial communication network, for example, satellite communication, has significant advantages such as global coverage, long-distance transmission, flexible networking, convenient deployment, and no limitation from geographical conditions, and has been widely applied to a plurality of fields such as maritime communication, positioning and navigation, disaster relief, scientific experiments, video broadcasting, and earth observation.

To improve reliability of data transmission, a hybrid automatic repeat request (HARQ) is used in a non-terrestrial network (NTN). When receiving newly transmitted data, a terminal device clears a buffer, and stores the newly transmitted data in the buffer. When receiving retransmitted data, the terminal device combines the retransmitted data and data in the buffer. However, when the terminal device receives retransmitted data after missing detection of data sent by a satellite, the terminal device cannot determine whether the retransmitted data is retransmitted data of the data of which the detection was missed or retransmitted data of the data before the detection was missed, and may incorrectly combine the retransmitted data. Consequently, reliability of data transmission is reduced.

### SUMMARY

This disclosure provides a communication method and a communication apparatus, so that a type of data to be transmitted can be accurately determined, and the data can be correctly processed, thereby improving reliability of data transmission.

According to a first aspect, a communication method is provided. The method may be performed by a terminal device. The terminal device herein may be the terminal device itself, or may be a processor, a module, a chip, a chip system, or the like that is in the terminal device and that implements the method. This is not limited in this disclosure. The method includes: The terminal device receives first control information and first data from a network device, where the first control information is used to schedule the first data, the first control information includes first information and second information, the first information and the second information indicate that the first data is newly transmitted data or retransmitted data, and indication manners of the first information and the second information are different. The terminal device processes the first data based on the first control information.

The first control information is used to schedule the first data. For example, the first control information may include downlink control information (DCI).

In this embodiment of this disclosure, a type of the first data may be the newly transmitted data or may be the retransmitted data. Specifically, the newly transmitted data is new data sent by the network device to the terminal device, and the retransmitted data is repeatedly transmitted data of a previous piece of newly transmitted data.

The terminal device may use different processing manners for the newly transmitted data and the retransmitted data. A HARQ is used as an example. After receiving the newly transmitted data, the terminal device stores the newly transmitted data in a buffer. If a capacity of the buffer is small, the terminal device may clear the data in the buffer and then store the newly transmitted data. After receiving the retransmitted data, the terminal device combines the retransmitted data. For example, the terminal device sequentially receives newly transmitted data 1, retransmitted data 1, and retransmitted data 2. Both the retransmitted data 1 and the retransmitted data 2 are repeatedly transmitted data of the newly transmitted data 1. After receiving the newly transmitted data 1, the terminal device clears the buffer, and stores the newly transmitted data 1 in the buffer. After receiving the retransmitted data 1, the terminal device combines the retransmitted data 1 and the newly transmitted data 1. After receiving the retransmitted data 2, the terminal device combines the retransmitted data 2 into a combination result of the retransmitted data 1 and the newly transmitted data 1. This improves integrity and reliability of data transmission.

It should be noted that both the newly transmitted data and the retransmitted data are relative to a previous piece of transmitted data. To be specific, if content of the newly transmitted data and content of the retransmitted data are essentially the same as that of a previous piece of data, the newly transmitted data and the retransmitted data are determined as the retransmitted data; or if the content of the newly transmitted data and the content of the retransmitted data are essentially different from that of the previous piece of data, the newly transmitted data and the retransmitted data are determined as the newly transmitted data.

In this embodiment of this disclosure, that two pieces of information indicate a data type and indication manners of the two pieces of information are different indicates that two different manners are used to jointly indicate the data type in this embodiment of this disclosure. For example, the data type may be directly indicated by using a value of a field, or the data type may be indicated by comparing control information received last time with control information received this time. Whether there is data that misses to be detected may be determined in different indication manners. For example, if comparison between the control information received last time and the control information received this time indicates that data received this time is retransmitted data, but a value of a field indicates newly transmitted data, the terminal device may determine that the data received this time is the newly transmitted data, and miss detection of data occurs on the terminal device, that is, the terminal device does not receive a previous piece of data of data sent by the network device this time.

According to the foregoing solution, the terminal device may determine, based on two types of indication information, whether received data is newly transmitted data or retransmitted data, and perform corresponding processing on the data based on a determining result. Performing cross comparison in the two indication manners can determine whether there is data that misses to be detected, thereby improving data type determining accuracy and reliability of data transmission.

With reference to the first aspect, in some implementations of the first aspect, that the terminal device processes the first data based on the first control information includes: determining, based on the first control information, whether the first data is retransmitted data or newly transmitted data.

The terminal device may determine the first data based on indication results of the second information and the first information in the first control information.

For example, if the indication result of the second information is the same as that of the first information, the terminal device determines that the first data is corresponding data. For example, if both the second information and the first information indicate that the first data is newly transmitted data, the terminal device determines that the first data is newly transmitted data. If the indication result of the second information is different from that of the first information, the terminal device determines that the terminal device misses detection of a previous piece of data and determines that the first data is newly transmitted data.

The first data is determined by combining the two indication results in two manners, so that determining accuracy of the terminal device is improved, and the terminal device can correctly process the first data. This improves reliability of data transmission.

With reference to the first aspect, in some implementations of the first aspect, when the first data is newly transmitted data, a value carried in the first information in the first control information is different from a value carried in the first information in second control information, where the second control information is used to schedule second data, and the second data is data sent by the network device before the first data; and when the first data is retransmitted data, the value carried in the first information in the first control information is the same as the value carried in the first information in the second control information. Alternatively, when the first data is newly transmitted data, the value carried in the first information in the first control information is the same as the value carried in the first information in the second control information; and when the first data is retransmitted data, the value carried in the first information in the first control information is different from the value carried in the first information in the second control information.

For example, the first information includes a new data indicator (NDI) field, and a value that may be carried in the NDI is 0 or 1. If data this time is newly transmitted data compared with data last time, values of the NDI in control information corresponding to the two times of data are different. If the data this time is newly transmitted data compared with the data last time, the values of the NDI in the control information corresponding to the two times of data are the same. A type of the data may be indicated by using a 1-bit field, thereby saving transmission resources.

With reference to the first aspect, in some implementations of the first aspect, the second information includes a first value or a second value, the first value indicates newly transmitted data, and the second value indicates retransmitted data.

In the foregoing solution, the second information includes an existing field to define the data type. For example, a HARQ-ACK resource field is reused, and the second information may also include a newly added field to define the data type. The existing field is reused, so that transmission resources can be saved.

According to the foregoing solution, the second information indicates, by using a specific value, whether the first data is newly transmitted data or the retransmitted data, so that the terminal device can more intuitively determine the first data. This reduces a calculation amount of the terminal device.

With reference to the first aspect, in some implementations of the first aspect, when the first data is newly transmitted data, the second information in the first control information includes a first field; and when the first data is retransmitted data, the second information in the first control information does not include the first field. Alternatively, when the first data is newly transmitted data, the second information in the first control information does not include the first field; and when the first data is retransmitted data, the second information in the first control information includes the first field.

For example, the first field may include a HARQ-ACK resource field.

According to the foregoing solution, whether the first field is included indicates whether the first data is newly transmitted data or the retransmitted data, so that signaling overheads can be reduced.

With reference to the first aspect, in some implementations of the first aspect, the second information indicates a value carried in the first information in the second control information.

The second control information is used to schedule the second data, and the second data is data sent by the network device before the first data.

The second information indicates the value of the first information during previous data transmission, so that the terminal device can avoid incorrect determining caused by miss detection of data last time. This improves determining correctness and reliability of the terminal device.

With reference to the first aspect, in some implementations of the first aspect, the method further includes: The terminal device receives configuration information from the network device, where the configuration information is used to configure receiving of retransmitted data.

According to the foregoing solution, the terminal device determines the data only after receiving the configuration information, so that the terminal device is prevented from determining each piece of data. This reduces a processing amount of the terminal device, and improves efficiency of data transmission.

With reference to the first aspect, in some implementations of the first aspect, the method further includes: The terminal device sends capability information to the network device, where the capability information indicates a data combination capability.

For example, the capability information includes at least one of the following: whether data combination is supported, a quantity of times that the buffer in the terminal device supports combination, and time for storing the data in the buffer in the terminal device.

According to the foregoing solution, only the terminal device having the data combination capability performs a determining process, so that the network device can distinguish between different terminal capabilities, thereby ensuring reliability of a data transmission link.

According to a second aspect, a communication method is provided. The method may be performed by a network device. The network device herein may be the network device itself, or may be a processor, a module, a chip, a chip system, or the like that is in the network device and that implements the method. This is not limited in this disclosure. The method includes: The network device determines first control information based on first data. The network device sends the first control information and the first data to a terminal device, where the first control information is used to schedule the first data, the first control information includes first information and second information, the first information and the second information indicate that the first data is newly transmitted data or retransmitted data, and indication manners of the first information and the second information are different.

With reference to the second aspect, in some implementations of the second aspect, the method further includes: The network device determines, based on link quality of a cell in which the terminal device is located, whether the first data is newly transmitted data or the retransmitted data.

The network device sends the newly transmitted data or the retransmitted data based on the link quality of the cell in which the terminal device is located, so that efficiency of data transmission can be ensured, and quality of data transmission can be ensured.

With reference to the second aspect, in some implementations of the second aspect, the method further includes: receiving capability information sent by the terminal device, where the capability information indicates a data combination capability of the terminal device; and the network device determines, based on the capability information, whether the first data is newly transmitted data or the retransmitted data.

In the foregoing solution, the network device configures blind retransmission enable based on the capability reported by the terminal device, so that capabilities of different terminal devices can be distinguished, thereby ensuring link reliability.

With reference to the second aspect, in some implementations of the second aspect, the method further includes: The network device sends configuration information to the terminal device, where the configuration information is used to configure the terminal device to receive the retransmitted data.

With reference to the second aspect, in some implementations of the second aspect, when the first data is newly transmitted data, a value carried in the first information in the first control information is different from a value carried in the first information in second control information, where the second control information is used to schedule second data, and the second data is data sent by the network device before the first data; and when the first data is retransmitted data, the value carried in the first information in the first control information is the same as the value carried in the first information in the second control information. Alternatively, when the first data is newly transmitted data, the value carried in the first information in the first control information is the same as the value carried in the first information in the second control information; and when the first data is retransmitted data, the value carried in the first information in the first control information is different from the value carried in the first information in the second control information.

With reference to the second aspect, in some implementations of the second aspect, the second information includes a first value or a second value, the first value indicates newly transmitted data, and the second value indicates retransmitted data.

With reference to the second aspect, in some implementations of the second aspect, when the first data is newly transmitted data, the second information in the first control information includes a first field; and when the first data is retransmitted data, the second information in the first control information does not include the first field. Alternatively, when the first data is newly transmitted data, the second information in the first control information does not include the first field; and when the first data is retransmitted data, the second information in the first control information includes the first field.

With reference to the second aspect, in some implementations of the second aspect, the second information indicates a value carried in the first information in the second control information.

According to a third aspect, a communication method is provided. The method may be performed by a terminal device. The terminal device herein may be the terminal device itself, or may be a processor, a module, a chip, a chip system, or the like that is in the terminal device and that implements the method. This is not limited in this disclosure. The method includes: The terminal device receives configuration information from a network device, where

the configuration information is used to configure whether to perform blind retransmission. The terminal device processes, based on the configuration information, data sent by the network device.

According to the foregoing solution, the terminal device performs corresponding processing on the data only after receiving the configuration information, so that the terminal device is prevented from determining each piece of data. This reduces a processing amount of the terminal device, and improves efficiency of data transmission.

With reference to the third aspect, in some implementations of the third aspect, if the configuration information is used to configure to not perform blind retransmission, all data received by the terminal device from the network device is newly transmitted data; or if the configuration information is used to configure to perform blind retransmission, the terminal device determines that the data received from the network device is the newly transmitted data or retransmitted data.

With reference to the third aspect, in some implementations of the third aspect, the terminal device sends capability information to the network device, where the capability information indicates a data combination capability, and the configuration information is determined based on the capability information.

For example, the capability information includes at least one of the following: whether data combination is supported, a quantity of times that a buffer in the terminal device supports combination, and time for storing the data in the buffer in the terminal device.

Specifically, if the capability information indicates that the terminal device does not have the data combination capability, the configuration information is used to configure to not perform blind retransmission.

According to a fourth aspect, a communication method is provided. The method may be performed by a network device. The network device herein may be the network device itself, or may be a processor, a module, a chip, a chip system, or the like that is in the network device and that implements the method. This is not limited in this disclosure. The method includes:

The network device determines configuration information, where the configuration information is used to configure whether to perform blind retransmission. The network device sends the configuration information to a terminal device.

With reference to the fourth aspect, in some implementations of the fourth aspect, the network device obtains link quality of a cell in which the terminal device is located, to determine the configuration information.

With reference to the fourth aspect, in some implementations of the fourth aspect, the network device obtains capability information of the terminal device to determine the configuration information, where the capability information indicates a data combination capability of the terminal device.

According to a fifth aspect, a communication method is provided. The method may be performed by a terminal device. The terminal device herein may be the terminal device itself, or may be a processor, a module, a chip, a chip system, or the like that is in the terminal device and that implements the method. This is not limited in this disclosure. The method includes:

When the terminal device determines that data sent by a network device is newly transmitted data, the terminal device stores the newly transmitted data, starts a counter, and resets the counter to zero, where the counter is used to count a quantity of pieces of retransmitted data; the terminal device determines that the data sent by the network device is retransmitted data and a value indicated by the counter is less than or equal to a threshold, and the terminal device performs data combination on the retransmitted data, and increases the value indicated by the counter by 1; or the terminal device determines that the data sent by the network device is the retransmitted data and the value indicated by the counter is greater than the threshold, and the terminal device stores the retransmitted data, and clears the counter.

In the foregoing solution, a maximum quantity of times of retransmitting the data is limited by using the counter, so that complexity of blind detection performed by the terminal device can be not increased, thereby ensuring link reliability.

With reference to the fifth aspect, in some implementations of the fifth aspect, the terminal device receives configuration information from the network device, where the configuration information includes the threshold.

According to a sixth aspect, a communication method is provided. The method may be performed by a terminal device. The terminal device herein may be the terminal device itself, or may be a processor, a module, a chip, a chip system, or the like that is in the terminal device and that implements the method. This is not limited in this disclosure. The method includes:

When the terminal device determines that data sent by a network device is newly transmitted data, the terminal device stores the newly transmitted data, resets a timer to zero, and starts the timer; and the terminal device determines that the data sent by the network device is retransmitted data and a value indicated by the timer is less than or equal to a threshold, the terminal device performs data combination on the retransmitted data; or the terminal device determines that the data sent by the network device is the retransmitted data and the value indicated by the timer is greater than the threshold, the terminal device stores the retransmitted data, and clears the timer.

In the foregoing solution, a maximum time interval for retransmitting the data is limited by using the timer, so that complexity of blind detection performed by the terminal device can be not increased, thereby ensuring link reliability.

With reference to the sixth aspect, in some implementations of the sixth aspect, the terminal device receives configuration information from the network device, where the configuration information includes the threshold.

According to a seventh aspect, a communication apparatus is provided. The apparatus includes a transceiver unit and a processing unit. The transceiver unit is configured to receive first control information and first data from a network device, where the first control information is used to schedule the first data, the first control information includes first information and second information, the first information and the second information indicate that the first data is newly transmitted data or retransmitted data, and indication manners of the first information and the second information are different. The processing unit is configured to process the first data based on the first control information.

It should be understood that the seventh aspect is an implementation on an apparatus side corresponding to the first aspect. Supplements, explanations, and descriptions of beneficial effect of the first aspect are also applicable to the seventh aspect. Details are not described again.

According to an eighth aspect, a communication apparatus is provided. The apparatus includes a transceiver unit and a processing unit. The processing unit is configured to determine first control information based on first data. The transceiver unit is configured to send the first control information and the first data to a terminal device, where the first control information is used to schedule the first data, the first control information includes first information and second information, the first information and the second information indicate that the first data is newly transmitted data or retransmitted data, and indication manners of the first information and the second information are different.

It should be understood that the eighth aspect is an implementation on an apparatus side corresponding to the second aspect. Supplements, explanations, and descriptions of beneficial effect of the second aspect are also applicable to the eighth aspect. Details are not described again.

According to a ninth aspect, a communication apparatus is provided. The apparatus includes a transceiver unit and a processing unit. The transceiver unit is configured to receive configuration information from a network device, where the configuration information is used to configure whether to perform blind retransmission. The processing unit is configured to process, based on the configuration information, data sent by the network device.

It should be understood that the ninth aspect is an implementation on an apparatus side corresponding to the third aspect. Supplements, explanations, and descriptions of beneficial effect of the third aspect are also applicable to the ninth aspect. Details are not described again.

According to a tenth aspect, a communication apparatus is provided. The apparatus includes a transceiver unit and a processing unit. The processing unit is configured to determine configuration information, where the configuration information is used to configure whether to perform blind retransmission. The transceiver unit is configured to send the configuration information to a terminal device.

It should be understood that the tenth aspect is an implementation on an apparatus side corresponding to the fourth aspect. Supplements, explanations, and descriptions of beneficial effects of the fourth aspect are also applicable to the tenth aspect. Details are not described again.

According to an eleventh aspect, a communication apparatus is provided. The apparatus includes a processing unit and a transceiver unit. The transceiver unit is configured to receive data sent by a network device. The processing unit is configured to: determine that the data sent by the network device is newly transmitted data, store the newly transmitted data, reset a counter to zero, and start the counter, where the counter is used to count a quantity of pieces of retransmitted data; determine that the data sent by the network device is retransmitted data and a value indicated by the counter is less than or equal to a threshold, perform data combination on the retransmitted data, and increase the value indicated by the counter by 1; or determine that the data sent by the network device is the retransmitted data and the value indicated by the counter is greater than the threshold, store the retransmitted data, and clear the counter.

It should be understood that the eleventh aspect is an implementation on an apparatus side corresponding to the fifth aspect. Supplements, explanations, and descriptions of beneficial effect of the fifth aspect are also applicable to the eleventh aspect. Details are not described again.

According to a twelfth aspect, a communication apparatus is provided. The apparatus includes a transceiver unit and a processing unit. The transceiver unit is configured to receive data from a network device. The processing unit is configured to: determine that the data sent by the network device is newly transmitted data, store the newly transmitted data, reset a timer to zero, and start the timer; and determine that the data sent by the network device is retransmitted data and a value indicated by the timer is less than or equal to a threshold, and perform data combination on the retransmitted data; or determine that the data sent by the network device is the retransmitted data and the value indicated by the timer is greater than the threshold, store the retransmitted data, and clear the timer.

It should be understood that the twelfth aspect is an implementation on an apparatus side corresponding to the sixth aspect. Supplements, explanations, and descriptions of beneficial effects of the sixth aspect are also applicable to the twelfth aspect. Details are not described again.

According to a thirteenth aspect, this disclosure provides a communication apparatus. The communication apparatus includes a processor, configured to implement the method according to any one of the first aspect to the sixth aspect or the implementations of the first aspect to the sixth aspect. The processor is coupled to a memory, and the memory is configured to store instructions and data; and when the processor executes the instructions stored in the memory, the processor may implement the method according to any one of the first aspect to the sixth aspect or the implementations of the first aspect to the sixth aspect.

Optionally, the communication apparatus may further include the memory. Optionally, the memory may be coupled to the processor. Optionally, the communication apparatus may further include a communication interface. The communication interface is used by the apparatus to communicate with another device. For example, the communication interface may be a transceiver, a hardware circuit, a bus, a module, a pin, or another type of communication interface.

In an example, the communication apparatus may be a network device, for example, an access network device, or may be an apparatus, a module, a chip, or the like disposed in the network device, or may be an apparatus that can be used in cooperation with the network device.

In another example, the communication apparatus may be a terminal device, may be an apparatus, a module, a chip, or the like disposed in the terminal device, or may be an apparatus that can be used together with the terminal device.

According to a fourteenth aspect, this disclosure provides a communication system. The communication system includes a terminal device and a network device. The terminal device is the terminal device according to any one of the first aspect, the third aspect, the fifth aspect, or the sixth aspect or the implementations of the first aspect, the third aspect, the fifth aspect, or the sixth aspect, and the network device is the network device according to any one of the second aspect or the fourth aspect or the implementations of the second aspect or the fourth aspect.

According to a fifteenth aspect, this disclosure further provides a computer program. When the computer program is run on a computer, the computer is enabled to perform the method according to any one of the first aspect to the sixth aspect or the implementations of the first aspect to the sixth aspect.

According to a sixteenth aspect, this disclosure further provides a computer program product. The computer program product includes instructions; and when the instructions are run on a computer, the computer is enabled to perform the method according to any one of the first aspect to the sixth aspect or the implementations of the first aspect to the sixth aspect.

According to a seventeenth aspect, this disclosure further provides a computer-readable storage medium. The computer-readable storage medium stores a computer program or instructions; and when the computer program or the instructions are run on a computer, the computer is enabled to perform the method according to any one of the first aspect to the sixth aspect or the implementations of the first aspect to the sixth aspect.

According to an eighteenth aspect, this disclosure further provides a chip. The chip is configured to read a computer program stored in a memory, to perform the method according to any one of the first aspect to the sixth aspect or the implementations of the first aspect to the sixth aspect; or the chip is configured to perform the method according to any one of the first aspect to the sixth aspect or the implementations of the first aspect to the sixth aspect.

According to a nineteenth aspect, this disclosure further provides a chip system. The chip system includes a processor, configured to support an apparatus in implementing the method according to any one of the first aspect to the sixth aspect or the implementations of the first aspect to the sixth aspect. In a possible design, the chip system further includes a memory, and the memory is configured to store a program and data that are necessary for the apparatus. The chip system may include a chip, or may include a chip and another discrete component.

### BRIEF DESCRIPTION OF DRAWINGS

FIG. 1 is a diagram of a communication system to which an embodiment of this disclosure is applicable.

FIG. 2 is a diagram of a communication method according to an embodiment of this disclosure;

FIG. 3 is a diagram of data transmission according to an embodiment of this disclosure;

FIG. 4 is a diagram of data transmission according to an embodiment of this disclosure;

FIG. 5 is a diagram of data transmission according to an embodiment of this disclosure;

FIG. 6 is a diagram of data transmission according to an embodiment of this disclosure;

FIG. 7 is a diagram of data transmission according to an embodiment of this disclosure;

FIG. 8 is a diagram of data transmission according to an embodiment of this disclosure;

FIG. 9 is a diagram of data transmission according to an embodiment of this disclosure;

FIG. 10 is a diagram of data transmission according to an embodiment of this disclosure;

FIG. 11 is a diagram of a communication method according to an embodiment of this disclosure;

FIG. 12 is a diagram of data transmission according to an embodiment of this disclosure;

FIG. 13 is a diagram of a communication method according to an embodiment of this disclosure;

FIG. 14 is a diagram of a structure of a communication apparatus according to an embodiment of this disclosure; and

FIG. 15 is a diagram of a structure of a communication apparatus according to an embodiment of this disclosure.

### DESCRIPTION OF EXAMPLE EMBODIMENTS

The following describes technical solutions of this disclosure with reference to accompanying drawings.

The technical solutions of this disclosure may be applied to a non-terrestrial network (NTN) system such as a satellite communication system, a high altitude platform station (HAPS) communication system, or an uncrewed aerial vehicle, for example, an integrated communication and navigation (IcaN) system, a global navigation satellite system (GNSS), and an ultra-dense low-orbit satellite communication system.

The satellite communication system may be integrated with a conventional mobile communication system. For example, the mobile communication system may be a 4th generation (4G) communication system (for example, a long term evolution (LTE) system), a worldwide interoperability for microwave access (WiMAX) communication system, a 5th generation (5G) communication system (for example, a new radio (NR) system), a future mobile communication system, and the like.

The satellite communication system includes a user equipment (UE) and a network device. The user equipment may also be referred to as a user terminal, a mobile station, or the like. The network device may include one or more satellites and one or more terrestrial station devices. The terrestrial station device may also be referred to as a core network device. The satellite may be a low earth orbit (LEO) satellite, a non-geostationary earth orbit (NGEO) satellite, or the like. The satellite may provide a communication service, a navigation service, a positioning service, and the like for the terminal device by using a plurality of beams. The satellite uses the plurality of beams to cover a service area, and different beams may be used to perform communication in one or more manners of time division, frequency division, and space division. The satellite performs wireless communication with the terminal device by using a broadcast communication signal, a navigation signal, and the like. The satellite may perform wireless communication with a terrestrial station device. The satellite mentioned in embodiments of this disclosure may be a satellite base station, may include an orbit receiver or a repeater configured to relay information, or may be a network side device mounted on the satellite.

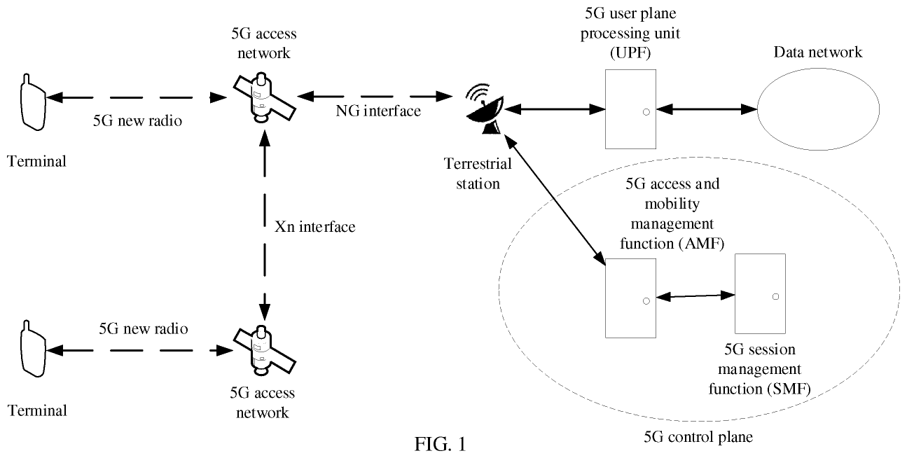

FIG. 1 is a diagram of a communication system 100 to which an embodiment of this disclosure is applicable. As shown in FIG. 1, a satellite provides a communication service for a terminal device by using a plurality of beams. The satellite in this scenario is a non-geostationary earth orbit (NGEO) satellite, and the satellite is connected to a core network device. The satellite uses the plurality of beams to cover a service area, and different beams may be used to perform communication in one or more manners of time division, frequency division, and space division.

The satellite provides communication and navigation services for the terminal device by broadcasting a communication signal and a navigation signal. The satellite mentioned in this embodiment of this disclosure may alternatively be a satellite base station or a network side device mounted on the satellite.

The satellite communication system includes a transparent satellite architecture and a non-transparent satellite architecture. Transparent transmission is also referred to as bent-pipe forwarding transmission, only frequency conversion and signal amplification are performed on a signal on a satellite, and the satellite is transparent to the signal. Non-transparent transmission is also referred to as regenerative (on-satellite access/processing) transmission. That is, the satellite has some or all of functions of a base station.

The terminal device mentioned in this embodiment of this disclosure includes various handheld devices, vehicle-mounted devices, wearable devices, or compute devices that have a wireless communication function, or other processing devices connected to a wireless modem, and may be a user equipment (UE), an access terminal, a subscriber unit, a subscriber station, a mobile station, a remote station, a remote terminal, a mobile device, a user terminal, a terminal, a wireless communication device, a user agent, or a user apparatus. The terminal device may alternatively be a satellite phone, a cellular phone, a smartphone, a wireless data card, a wireless modem, or a machine-type communication device, or may be a cordless phone, a session initiation protocol (SIP) phone, a wireless local loop (WLL) station, a personal digital assistant (PDA), a handheld device or a compute device having a wireless communication function or another processing device connected to a wireless modem, a vehicle-mounted device or a wearable device, a virtual reality (VR) terminal device, an augmented reality (AR) terminal device, a wireless terminal in industrial control, a wireless terminal in self-driving, a wireless terminal in telemedicine, a wireless terminal in a smart grid, a wireless terminal in transportation safety, a wireless terminal in a smart city, a wireless terminal in a smart home, a terminal device in a 5G network or a future communication network, or the like.

The terrestrial station device is, for example, a device in a core network (CN) in an existing mobile communication architecture (for example, a 3GPP access architecture of a 5G network) or a device in a core network in a future mobile communication architecture. As a bearer network, the core network provides an interface to a data network, provides communication connection, authentication, management, and policy control for the user equipment (UE), bears data services, and the like. The CN may further include network elements such as an access and mobility management function network element (AMF), a session management function network element (SMF), an authentication server function network element (AUSF), a policy control function (PCF), and a user plane function network element (UPF). The AMF network element is configured to manage access and mobility of the UE, and is mainly responsible for functions such as UE authentication, UE mobility management, and UE paging.

The network device may further include but is not limited to: an evolved NodeB (eNB), a baseband unit (BBU), an access point (AP) in a wireless fidelity (Wi-Fi) system, a wireless relay node, a wireless backhaul node, a transmission point (transmission point, TP), a transmission reception point (TRP), or the like. Alternatively, the network device may be a gNB, a TRP, or a TP in a 5G system, or one antenna panel or one group of antenna panels (including a plurality of antenna panels) of a base station in the 5G system. In addition, the network device may alternatively be a network node that forms a gNB or a TP, for example, a BBU, a distributed unit (DU), or the like. Alternatively, the network device may be a device responsible for a network side function in a device-to-device (D2D) communication system, a machine-to-machine (M2M) communication system, an internet of things (IoT) communication system, an internet of vehicles communication system, or another communication system.

A terrestrial mobile terminal UE accesses a network through 5G new radio. A 5G access network device is deployed on a satellite, and is connected to a terrestrial core network through a radio link. In addition, there is a radio link between satellites, to implement signaling exchange and user data transmission between access network devices. Network elements in FIG. 1 and interfaces of the network elements are described as follows.

A terminal device is a mobile device that supports 5G new radio, for example, a mobile phone and a pad typically. The terminal device may access a satellite network through an air interface and initiate a service such as a call or network access.

A 5G access network device mainly provides a radio access service, schedules a radio resource for an access terminal, provides a reliable wireless transmission protocol, a reliable data encryption protocol, and the like, and is, for example, a base station.

A 5G core network provides services such as user access control, mobility management, session management, user security authentication, and charging. The 5G core network includes a plurality of functional units, and may be divided into a control plane functional entity and a data plane functional entity. An access and mobility management function (AMF) is responsible for user access management, security authentication, and mobility management. A user plane unit (UPF) is responsible for functions such as managing user plane data transmission and traffic statistics.

A terrestrial station is responsible for forwarding signaling and service data between a satellite access network device and the 5G core network.

5G new radio is a radio link between the terminal and the access network device.

An Xn interface is an interface between the 5G access network device and the access network device, and is mainly for signaling exchange such as handover.

An NG interface is an interface between the 5G access network device and the 5G core network, and is mainly for exchanging signaling such as NAS of the core network and service data of users.

An application architecture in embodiments of this disclosure may include a non-terrestrial communication network (NTN). The non-terrestrial communication network includes nodes such as a satellite network, a high-altitude platform, and an uncrewed aerial vehicle, has significant advantages such as global coverage, long-distance transmission, flexible networking, convenient deployment, and no limitation from geographical conditions, and has been widely applied to a plurality of fields such as maritime communication, positioning and navigation, disaster relief, scientific experiments, video broadcasting, and earth observation. A terrestrial 5G network and a satellite network are integrated and complement each other to form an integrated communication network that provides seamless global coverage by sea, land, air, space, and ground, to meet a plurality of ubiquitous service requirements of users.

As an important part of the NTN, a next-generation satellite network generally has a trend of being ultra dense and heterogeneous. First, a scale of the satellite network develops from 66 satellites in an Iridium satellite constellation to 720 satellites in a Oneweb satellite constellation, and finally develops to 12000+ satellites in a Starlink ultra dense LEO satellite constellation. Second, the satellite network has a heterogeneous feature, and develops from a conventional single-layer communication network to a multi-layer communication network. A communication satellite network tends to have complex and diversified functions, and is gradually compatible with and supports functions such as navigation enhancement, earth observation, and on-orbit processing of multi-dimensional information.

A HARQ technology is used to transmit data in the NTN network. HARQ is a method for improving reliability of data transmission. A data packet that is incorrectly decoded is stored in a HARQ buffer, and is combined with a subsequently received retransmitted data packet to obtain a data packet that is more reliable than a data packet that is separately decoded (a “soft combination” process). Then, the combined data packet is decoded. If decoding still fails, a process of “requesting retransmission and then performing soft combination” is repeated.

A stop-and-wait protocol is used in the HARQ to send data. In the stop-and-wait protocol, after sending a piece of data, a transmit end stops and waits for an acknowledgement message. The receive end performs positive (ACK) or negative (NACK) acknowledgement on the data by using 1-bit information. In an NTN scenario, because a round-trip delay is large, if an original stop-and-wait protocol is used, a complete HARQ process (from sending data scheduling DCI to receiving a feedback) takes a long time, which greatly reduces a throughput. Therefore, a mechanism of disabling HARQ feedback is introduced in the NTN. To be specific, after receiving the data, the terminal device may not feed back a decoding status ACK/NACK of the data to the network device. Therefore, the network device cannot learn of a decoding result of each scheduling.

To ensure link quality, especially in a case in which a channel changes greatly, such as an NTN, there may be a random obstruction from a cloud or building. The network device needs to perform blind retransmission scheduling on scheduled data, and retransmit the data without knowing a scheduling result.

However, the terminal device cannot know whether the base station performs blind retransmission scheduling. In an NTN scenario, if missing detection of scheduled DCI is caused by obstruction from a building/cloud or the like, the terminal device cannot determine whether data scheduled by the DCI that misses to be detected is retransmitted data or newly transmitted data, and cannot determine whether the retransmitted data received after the missing detection is retransmitted data of the data that misses to be detected or retransmitted data of the data before the missing detection. Assuming that the network device sends data 1, data 2, and data 3 to the terminal device, the data 2 is newly transmitted data, and the data 3 is retransmitted data of the data 2, because the data 2 misses to be detected, the terminal device considers the data 3 as retransmitted data of the data 1, and combines the data 1 and the data 3. As a result, data combination is incorrect, decoding cannot be performed, and reliability of data transmission is reduced.

In view of this, for the problem that there may be miss detection of data in the NTN network, embodiments of this disclosure provide a communication method, so that a terminal device can accurately identify a type of data to process the data, thereby improving reliability of data transmission.

For ease of understanding of embodiments of this disclosure, the following descriptions are provided.

First, in this disclosure, unless otherwise specified or a logic conflict occurs, terms and/or descriptions in different embodiments are consistent and may be mutually referenced, and technical features in different embodiments may be combined based on an internal logical relationship thereof, to form a new embodiment.

Second, in this disclosure, “at least one” means one or more, and “a plurality of” means two or more. “And/or” describes an association relationship between associated objects, and indicates that three relationships may exist. For example, A and/or B may indicate the following cases: Only A exists, both A and B exist, and only B exists, where A and B may be singular or plural. In text descriptions of this disclosure, the character “/” usually indicates an “or” relationship between associated objects. “At least one of the following items (pieces)” or a similar expression thereof indicates any combination of these items, including a single item (piece) or any combination of a plurality of items (pieces). For example, at least one (piece) of a, b, and c may indicate a, b, c, a and b, a and c, b and c, or a, b, and c. Each of a, b, and c may be singular or plural.

Third, in this disclosure, “first”, “second”, and various numbers (for example, #1 and #2) are merely used for distinguishing for ease of description, but are not intended to limit the scope of embodiments of this disclosure, for example, are used to distinguish between different messages but not to describe a specific order or sequence. It should be understood that objects described in such a way are interchangeable in an appropriate circumstance, so that a solution other than embodiments of this disclosure can be described.

Fourth, in this disclosure, the terms “include”, “have”, and any variants thereof are intended to cover non-exclusive inclusion. For example, a process, method, system, product, or device that includes a series of steps or units is not necessarily limited to those expressly listed steps or units, but may include other steps or units not expressly listed or inherent to such a process, method, product, or device.

Fifth, in this disclosure, “indicate” may include a direct indication and an indirect indication. When a piece of indication information is described as indicating A, the indication information may directly indicate A or indirectly indicate A, but it does not indicate that the indication information definitely carries A.

Indication manners (indication schemes) in embodiments of this disclosure should be understood as covering various methods that can enable a to-be-indicated party to learn of to-be-indicated information. The to-be-indicated information may be sent as a whole, or may be divided into a plurality of pieces of sub-information for separate sending. In addition, sending periodicities and/or sending occasions of the sub-information may be the same or may be different. A specific sending method is not limited in this disclosure.

The “indication information” in embodiments of this disclosure may be an explicit indication, to be specific, a direct indication by using signaling, or an indication obtained based on a parameter indicated by signaling in combination with another rule or another parameter or obtained through deduction; or may be an implicit indication, to be specific, an indication obtained based on a rule, a relationship, or another parameter or obtained through deduction. This is not limited in this disclosure.

Sixth, in this disclosure, a “protocol” may be a standard protocol in the communication field, for example, may include a 5G protocol, an NR protocol, and a related protocol used in a future communication system. This is not limited in this disclosure. “Predefined” may include being defined in advance, for example, being protocol-defined. “Preconfigured” may be implemented by prestoring corresponding code or a corresponding table in a device, or may be implemented in another manner that may indicate related information. A specific implementation thereof is not limited in this disclosure.

Seventh, in this disclosure, “store” may mean being stored in one or more memories. The one or more memories may be separately disposed, or may be integrated into an encoder, a decoder, a processor, or a communication apparatus. Alternatively, a part of the one or more memories may be separately disposed, and a part the one or more memories may be integrated into a decoder, a processor, or a communication apparatus. A type of the memory may be a storage medium in any form. This is not limited in this disclosure.

Eighth, in this disclosure, if there is no logic conflict, “reporting”, “feeding back”, and “sending” may be interchanged.

The following describes in detail the communication method provided in embodiments of this disclosure with reference to the accompanying drawings, and the communication method may be applied to the communication system shown in FIG. 1.

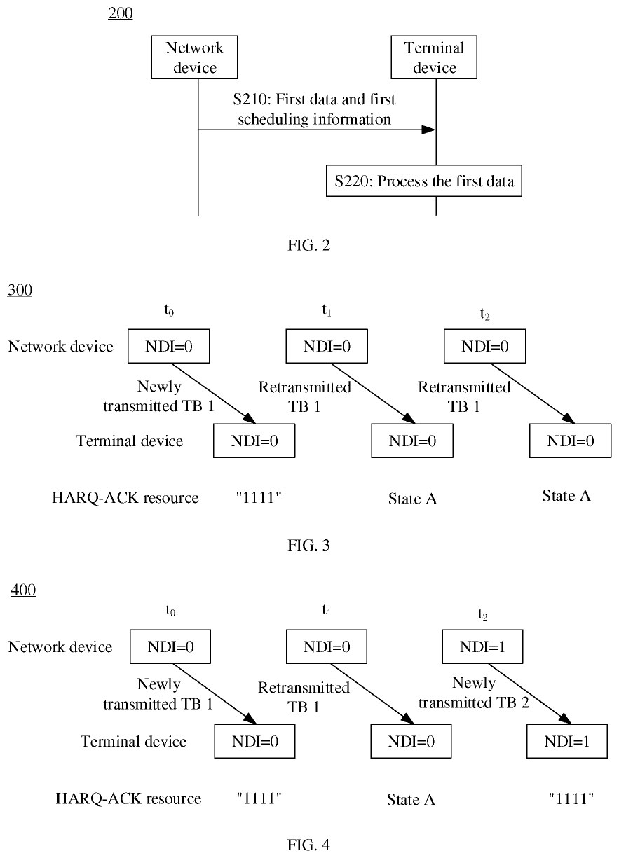

FIG. 2 is a diagram of a communication method 200 according to an embodiment of this disclosure.

S210: A network device sends first control information and first data to a terminal device, where the first control information is used to schedule the first data, the first control information includes second information and first information, the second information and the first information indicate that the first data is newly transmitted data or retransmitted data, and indication manners (indication schemes) of the second information and the first information are different.

In this embodiment of this disclosure, a type of data transmitted between the terminal device and the network device includes newly transmitted data or retransmitted data. The newly transmitted data is new data sent by the network device to the terminal device, and the newly transmitted data may also be referred to as initially transmitted data. The retransmitted data is repeatedly transmitted data of a previous piece of newly transmitted data.

In this embodiment of this disclosure, both the first information and the second information may indicate that the first data is retransmitted data or newly transmitted data, but the indication manners of the first information and the second information are different.

In the indication manner of the first information, a value carried in the first information in the first control information may be compared with a value carried in the first information in second control information to indicate whether the first data is retransmitted data or newly transmitted data. The second control information is used to schedule second data, and the second data is data sent by the network device before the first data, in other words, the second data is data, of the first data, that is sent last time.

In a possible implementation, when the first data is newly transmitted data, the value carried in the first information in the first control information is different from the value carried in the first information in the second control information; or when the first data is retransmitted data, the value carried in the first information in the first control information is the same as the value carried in the first information in the second control information. In other words, that the value carried in the first information in the first control information is different from the value carried in the first information in the second control information indicates that the first data is newly transmitted data; or that the value carried in the first information in the first control information is the same as the value carried in the first information in the second control information indicates that the first data is retransmitted data.

In a possible implementation, when the first data is newly transmitted data, the value carried in the first information in the first control information is the same as the value carried in the first information in the second control information; or when the first data is retransmitted data, the value carried in the first information in the first control information is different from the value carried in the first information in the second control information. In other words, that the value carried in the first information in the first control information is the same as the value carried in the first information in the second control information indicates that the first data is newly transmitted data; or that the value carried in the first information in the first control information is different from the value carried in the first information in the second control information indicates that the first data is retransmitted data.

For example, the first information includes an NDI field, the NDI field includes 1 bit, and a value carried in the NDI may be 0 or 1. Assuming that NDI=0 in the first information in the second control information, if the first data is newly transmitted data, NDI=1 in the first information in the first control information; or if the first data is retransmitted data, NDI=0 in the first information in the first control information. Assuming that NDI=1 in the first information in the second control information, if the first data is newly transmitted data, NDI=0 in the first information in the first control information; or if the first data is retransmitted data, NDI=1 in the first information in the first control information.

It should be understood that in this embodiment of this disclosure, because a value, of the NDI field, that is toggled may indicate the newly transmitted data, and the value, of the NDI field, that remains unchanged may indicate the retransmitted data, the first information may include the NDI field, to reduce signaling overheads and avoid increasing complexity of blind detection by the terminal device. However, the NDI is merely an example of the first information. Actually, the first information may include another field carrying a value, and whether data is newly transmitted data or retransmitted data is indicated by using a result of comparing a value carried in a field in current data transmission with a value carried in a corresponding field in previous data transmission. For example, the field may be a newly added field. This is not limited in this disclosure.

In a possible implementation, the second information directly indicates a data type of a field by using a value in the second information.

Specifically, the second information includes a first value or a second value, the first value indicates newly transmitted data, and the second value indicates retransmitted data.

For example, the second information includes a HARQ-ACK resource field. In an NB IoT, a HARQ-ACK resource has 4 bits in total, and there are 16 states in total. The HARQ-ACK resource is configured to be in a state “1111” to indicate that HARQ feedback is disabled. Whether the HARQ feedback is required needs to be configured identically for the newly transmitted data and the retransmitted data. To be specific, the newly transmitted data does not need to be fed back, and the retransmitted data also does not need to be fed back; or the newly transmitted data needs to be fed back, and the retransmitted data also needs to be fed back. Therefore, in a scenario in which the HARQ feedback is disabled, only a HARQ-ACK resource field in DCI for scheduling the newly transmitted data needs to be used to indicate that the HARQ feedback is disabled, and a HARQ-ACK resource field in DCI for scheduling the retransmitted data does not need to be used to indicate that the HARQ feedback is disabled. In this case, the state “1111” in the HARQ-ACK resource field may be used to indicate the newly transmitted data, and a state A in the HARQ-ACK resource field may be used to indicate the retransmitted data. The state A is a state in the HARQ-ACK resource field other than the state “1111”.

Further, for a same terminal device, a value of the state A may be fixed, or may be any change value other than “1111”. For different terminal devices, values of the state A may be the same, that is, one fixed value is allocated to each terminal device as the state A; or the values of the state A may be different. This is not limited in this disclosure.

It should be understood that in this embodiment of this disclosure, reusing the HARQ-ACK resource field in the second information can reduce signaling overheads. However, the HARQ-ACK resource field is merely an example of the second information. Actually, the second information may include a newly added field. This is not limited in this disclosure.

In a possible implementation, the second information indicates a data type of a field by using a format length of the second information.

Specifically, when the first data is newly transmitted data, the second information in the first control information includes a first field, that is, the second information is in a long format; and when the first data is retransmitted data, the second information in the first control information does not include the first field, that is, the second information is in a short format. Alternatively, when the first data is newly transmitted data, the second information in the first control information does not include the first field, that is, the second information is in a short format; and when the first data is retransmitted data, the second information in the first control information includes the first field, that is, the second information is in a long format.

For example, the first field includes a HARQ-ACK resource field. If the first data is newly transmitted data, the second information in the first control information includes the HARQ-ACK resource field; and if the first data is retransmitted data, the second information in the first control information does not include the HARQ-ACK resource field.

It should be understood that in this embodiment of this disclosure, reusing the HARQ-ACK resource field in the second information can reduce signaling overheads. However, whether the HARQ-ACK resource field is included is merely an example of distinguishing between the long format and the short format of the second information. Actually, a field may be newly added to the second information in the long format to distinguish the long format from the short format. This is not limited in this disclosure.

In a possible implementation, the second information may indicate the value of the first information in the second control information, and the second information indicates, with reference to the first information in the first control information, that the first data is newly transmitted data or the retransmitted data. The second control information is used to schedule the second data, and the second data is the data sent by the network device before the first data, in other words, the second data is the data, of the first data, that is sent last time.

For example, the first information includes an NDI, the second information includes a new field LNDI (last NDI), and the LNDI indicates a value of the NDI in the second control information. If a value of the LNDI is different from that of the current NDI, the first data is newly transmitted data; or if the value of the LNDI is the same as that of the current NDI, the first data is retransmitted data. The value of the LNDI is shown in Table 1.

TABLE 1

| NDI | LNDI | Data type |
|---|---|---|
| 1 | 0 | Newly transmitted data |
| 1 | 1 | Retransmitted data |
| 0 | 0 | Retransmitted data |
| 0 | 1 | Newly transmitted data |

The LNDI may reuse 1 bit of the HARQ-ACK resource field, or may additionally introduce 1 bit. This is not limited in this disclosure.

The second information may alternatively indicate whether the value of the first information in the second control information is the same as the value of the first information in the first control information, and the second information indicates, with reference to the first information in the first control information, that the first data is newly transmitted data or the retransmitted data. The second control information is used to schedule the second data, and the second data is the data sent by the network device before the first data, in other words, the second data is the data, of the first data, that is sent last time.

For example, the first information includes an NDI, the second information includes a new field CNDI (compared NDI), and the CNDI indicates whether a value of the NDI in the first control information is the same as a value of the NDI in the second control information.

In a possible implementation, if the value of the NDI in the first control information is the same as the value of the NDI in the second control information, the CNDI is 1, and the first data is retransmitted data; or if the value of the NDI in the first control information is different from the value of the NDI in the second control information, the CNDI is 0, and the first data is newly transmitted data. The value of the CNDI is shown in Table 2.

TABLE 2

| NDI | CNDI | Data type |
|---|---|---|
| 1 | 0 | Newly transmitted data |
| 1 | 1 | Retransmitted data |
| 0 | 1 | Retransmitted data |
| 0 | 0 | Newly transmitted data |

In a possible implementation, if the value of the NDI in the first control information is different from the value of the NDI in the second control information, the CNDI is 1, and the first data is newly transmitted data; or if the value of the NDI in the first control information is the same as the value of the NDI in the second control information, the CNDI is 0, and the first data is retransmitted data. The value of the CNDI is shown in Table 3.

TABLE 3

| NDI | CNDI | Data type |
|---|---|---|
| 1 | 1 | Newly transmitted data |
| 1 | 0 | Retransmitted data |
| 0 | 0 | Retransmitted data |
| 0 | 1 | Newly transmitted data |

The CNDI may reuse 1 bit of the HARQ-ACK resource field, or may additionally introduce 1 bit. This is not limited in this disclosure.

S220: The terminal device processes the first data based on the first control information.

In this embodiment of this disclosure, that the terminal device processes the first data includes: determining, based on the first control information, whether the first data is newly transmitted data or the retransmitted data.

That the terminal device processes the first data further includes: storing or combining the first data based on the type of the first data.

If only one piece of information indicates that the first data is newly transmitted data or the retransmitted data, the terminal device may incorrectly determine that the first data is newly transmitted data or the retransmitted data because the terminal device misses detection of some data.

For ease of description, an example in which the control information includes the DCI and the first information includes the NDI is used in the following descriptions.

In a possible implementation, the second information includes a HARQ-ACK resource field, “1111” in the HARQ-ACK resource field indicates newly transmitted data, and a state A indicates retransmitted data. The state A may be RRC-preconfigured.

Specifically, if the terminal device receives DCI for scheduling data, where an NDI in the DCI is toggled compared with an NDI in DCI that is in a same process and that is received last time, and a HARQ-ACK resource field in the DCI is “1111”, the terminal device determines that the data scheduled by using the DCI is the newly transmitted data; or if the terminal device receives the DCI for scheduling the data, where the NDI in the DCI is not toggled compared with the NDI in the DCI that is in the same process and that is received last time, and the HARQ-ACK resource field in the DCI is the state A, the terminal device determines that the data scheduled by using the DCI is the retransmitted data.

For example, FIG. 3 to FIG. 6 are diagrams of data transmission according to embodiments of this disclosure. A transport block (TB) is to-be-transmitted data. The terminal device receives a newly transmitted TB 1 at a moment t₀, where a value of a HARQ-ACK resource field is “1111”, and NDI=0. The terminal device clears soft bit information in a previous buffer, and replaces the soft bit information with soft bit information decoded by a newly transmitted TB 1.

In FIG. 3, at a moment t₁, the terminal device receives a new scheduling, where NDI=0 in DCI, and the NDI is not toggled compared with an NDI of the newly transmitted TB 1; determines, based on the NDI, that the data is retransmitted data, and a HARQ-ACK resource field in the DCI is a state A; and determines, based on a HARQ-ACK resource, that the data is the retransmitted data; and the terminal device acknowledges, based on comprehensive determining, that the data in this scheduling is the retransmitted data of the newly transmitted TB 1 (a retransmitted TB 1), and performs soft combination on a decoding result of the data at the moment t₁ and the soft bit information in the buffer. At a moment t₂, the terminal device receives a new scheduling, where NDI=0 in the DCI, and the NDI is not toggled compared with an NDI of the retransmitted TB 1; determines, based on the NDI, that the data is retransmitted data, and a HARQ-ACK resource field in the DCI is a state A; and determines, based on a HARQ-ACK resource, that the data is the retransmitted data; and the terminal device acknowledges, based on comprehensive determining, that the data in this scheduling is the retransmitted data, and performs soft combination on a decoding result of the data at the moment t₂ and the soft bit information in the buffer.

In FIG. 4, at a moment t₁, the terminal device receives a new scheduling, where NDI=0 in DCI, and the NDI is not toggled compared with an NDI of the newly transmitted TB 1; determines, based on the NDI, that the data is retransmitted data, and a HARQ-ACK resource field in the DCI is a state A; and determines, based on a HARQ-ACK resource, that the data is the retransmitted data; and the terminal device acknowledges, based on comprehensive determining, that the data in this scheduling is the retransmitted data of the newly transmitted TB 1 (a retransmitted TB 1), and performs soft combination on a decoding result of the data at the moment t₁ and the soft bit information in the buffer. At a moment t₂, the terminal device receives a new scheduling, where NDI=1 in the DCI, and the NDI is toggled compared with an NDI of the retransmitted TB 1; determines, based on the NDI, that the data is newly transmitted data, and a HARQ-ACK resource field in the DCI is “1111”; and determines, based on a HARQ-ACK resource, that the data is the newly transmitted data; and the terminal device acknowledges, based on comprehensive determining, that the data in this scheduling is the newly transmitted data (a newly transmitted TB 2), clears soft bit information in a previous buffer, and replaces the soft bit information with soft bit information of a decoding result of the data at the moment t₂.

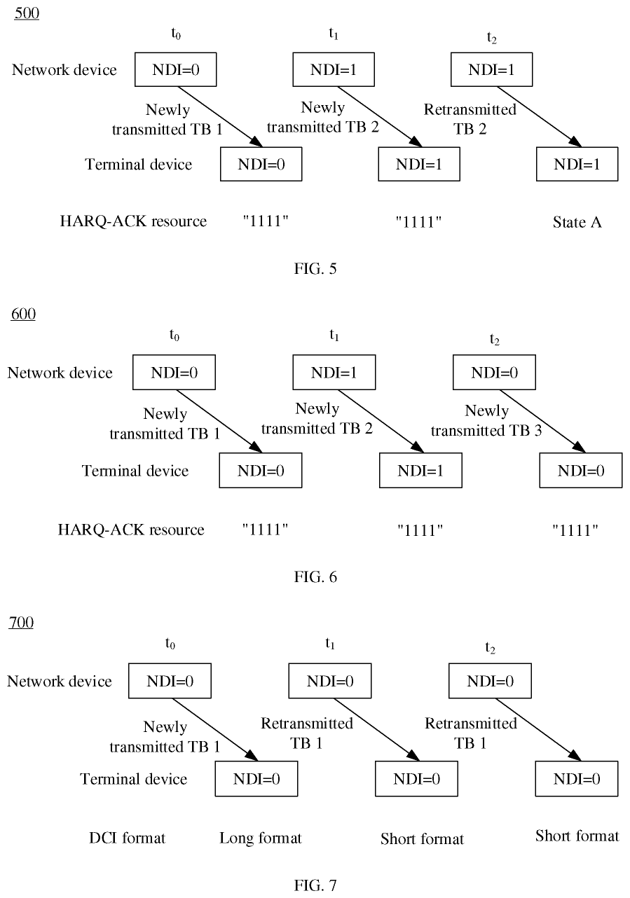

In FIG. 5, at a moment t₁, the terminal device receives a new scheduling, where NDI=1 in DCI, and the NDI is toggled compared with an NDI of the newly transmitted TB 1; determines, based on the NDI, that the data is newly transmitted data, and a HARQ-ACK resource field in the DCI is “1111”; and determines, based on a HARQ-ACK resource, that the data is the newly transmitted data; and the terminal device acknowledges, based on comprehensive determining, that the data in this scheduling is the newly transmitted data (a newly transmitted TB 2), clears soft bit information in a previous buffer, and replaces the soft bit information with soft bit information of a decoding result of the data at the moment t₁. At a moment t₂, the terminal device receives a new scheduling, where NDI=1 in the DCI, and the NDI is not toggled compared with an NDI of the newly transmitted TB 2; determines, based on the NDI, that the data is retransmitted data, and a HARQ-ACK resource field in the DCI is a state A; and determines, based on a HARQ-ACK resource, that the data is the retransmitted data; and the terminal device acknowledges, based on comprehensive determining, that the data in this scheduling is the retransmitted data of the newly transmitted TB 2 (a retransmitted TB 2), and performs soft combination on a decoding result of the data at the moment t₂ and the soft bit information in the buffer.

In FIG. 6, at a moment t₁, the terminal device receives a new scheduling, where NDI=1 in DCI, and the NDI is toggled compared with an NDI of the newly transmitted TB 1; determines, based on the NDI, that the data is newly transmitted data, and a HARQ-ACK resource field in the DCI is “1111”; and determines, based on a HARQ-ACK resource, that the data is the newly transmitted data; and the terminal device acknowledges, based on comprehensive determining, that the data in this scheduling is the newly transmitted data (a newly transmitted TB 2), clears soft bit information in a previous buffer, and replaces the soft bit information with soft bit information of a decoding result of the data at the moment t₁. At a moment t₂, the terminal device receives a new scheduling, where NDI=0 in the DCI, and the NDI is toggled compared with an NDI of the newly transmitted TB 2; determines, based on the NDI, that the data is newly transmitted data, and a HARQ-ACK resource field in the DCI is “1111”; and determines, based on a HARQ-ACK resource, that the data is the newly transmitted data; and the terminal device acknowledges, based on comprehensive determining, that the data in this scheduling is the newly transmitted data (a newly transmitted TB 3), clears soft bit information in a previous buffer, and replaces the soft bit information with soft bit information of a decoding result of the data at the moment t₂.

The solutions in embodiments of this disclosure may be applied to not only a scenario in which the terminal device normally receives data, but also a scenario in which the terminal device misses detection of data, to improve reliability and accuracy of data transmission. The data transmission scenarios in FIG. 3 to FIG. 6 are used as examples, and it is assumed that the terminal device misses detection of the data at the moment t₁.

In FIG. 3, the terminal device receives the new scheduling at the moment t₂, where NDI=0 in the DCI, and the NDI is not toggled compared with the NDI of the newly transmitted TB 1 at a moment t₀; determines, based on the NDI, that the data is the retransmitted data, and the HARQ-ACK resource field in the DCI is the state A; and determines, based on the HARQ-ACK resource, that the data is the retransmitted data; and the terminal device determines that the data at the moment t₂ is the retransmitted data of the newly transmitted TB 1, performs soft combination on the decoding result of the data at the moment t₂ and the soft bit information in the buffer, so that the terminal device can correctly determine the data type and correctly process the data after miss detection occurs.

In FIG. 4, the terminal device receives the new scheduling at the moment t₂, where NDI=1 in the DCI, and the NDI is toggled compared with the NDI of the newly transmitted TB 1 at a moment t₀; determines, based on the NDI, that the data is the newly transmitted data, and the HARQ-ACK resource field in the DCI is “1111”; and determines, based on the HARQ-ACK resource, that the data is the newly transmitted data; and the terminal device determines that the data at the moment t₂ is the newly transmitted data (the newly transmitted TB 2), clears the soft bit information in the previous buffer, and replaces the soft bit information with the soft bit information of the decoding result of the data at the moment t₂, so that the terminal device can correctly determine the data type and correctly process the data after miss detection occurs.

In FIG. 5, the terminal device receives the new scheduling at the moment t₂, where NDI=1 in the DCI, and the NDI is toggled compared with the NDI of the newly transmitted TB 1 at a moment t₀; determines, based on the NDI, that the data is the newly transmitted data, and the HARQ-ACK resource field in the DCI is the state A; and determines, based on the HARQ-ACK resource, that the data is the retransmitted data. Because the terminal device determines a conflict between the NDI and a result of determining based on the HARQ-ACK resource, the terminal device determines that miss detection occurs. Because the HARQ-ACK resource field in the DCI at the moment t₂ is the state A, the data at the moment t₂ is retransmitted data of data that misses to be detected. In this case, a value of an NDI of the data that misses to be detected is 1, the NDI is toggled compared with the NDI of the newly transmitted TB 1 at the moment t₀, and the data that misses to be detected is the newly transmitted data (the newly transmitted TB 2). Because the data at the moment t₂ is the retransmitted data of the newly transmitted TB 2, and the data is new data in comparison with the newly transmitted TB 1, the terminal device cannot perform soft combination on the decoding result of the data at the moment t₂ and the soft bit information in the buffer, and the terminal device may clear the soft bit information in the previous buffer, and replace the soft bit information with the soft bit information of the decoding result of the data at the moment t₂.

If the terminal device performs determining only based on the HARQ-ACK resource field in the DCI, the terminal device determines that the data at the moment t₂ is the retransmitted data of the newly transmitted TB 1, and performs soft combination on the decoding result of the data at the moment t₂ and the soft bit information in the buffer. Consequently, an error occurs in data decoding, and reliability of data transmission is affected.

In FIG. 6, the terminal device receives the new scheduling at the moment t₂, where NDI=0 in the DCI, and the NDI is not toggled compared with the NDI of the newly transmitted TB 1 at a moment t₀; determines, based on the NDI, that the data is the retransmitted data, and the HARQ-ACK resource field in the DCI is “1111”; and determines, based on the HARQ-ACK resource, that the data is the newly transmitted data. Because the terminal device determines a conflict between the NDI and a result of determining based on the HARQ-ACK resource, the terminal device determines that miss detection occurs. Because the HARQ-ACK resource field in the DCI at the moment t₂ is “1111”, the data at the moment t₂ is newly transmitted data of data that misses to be detected. In this case, a value of an NDI of the data that misses to be detected is 1, the NDI is toggled compared with the NDI of the newly transmitted TB 1 at the moment t₀, and the data that misses to be detected is the newly transmitted data. Therefore, the terminal device determines that the data at the moment t₂ is the newly transmitted data and the terminal device misses detection of a previous piece of newly transmitted data, and the terminal device may clear the soft bit information in the previous buffer, and replace the soft bit information with the soft bit information of the decoding result of the data at the moment t₂.

If the terminal device determines, only based on the NDI, the data received at the moment t₂, the value of the NDI is shown in Table 4.

TABLE 4

| Time | NDI |
|---|---|
| t₀ | 0 |
| t₁ | 1 |
| t₂ | 0 |

Because the terminal device misses detection of the data at the moment t₁, the terminal device compares the NDI received at the moment t₂ with the NDI received at the moment t₀, determines that the NDI is not toggled, determines that the data at the moment t₂ is the retransmitted data of the data at the moment t₀, and performs soft combination on the decoding result of the data at the moment t₂ and the soft bit information in the buffer. However, actually, the NDI at the moment t₂ is toggled compared with the NDI at the moment t₁, and the data at the moment t₂ is the newly transmitted data. Therefore, the terminal device incorrectly determines the data and incorrectly processes the data. As a result, an error occurs in data decoding, and reliability of data transmission is affected.

Based on the foregoing descriptions, regardless of whether miss detection occurs on the terminal device, the method provided in this embodiment of this disclosure may be that the terminal device correctly processes the data, thereby improving reliability of data transmission.

In a possible implementation, the second information may be the DCI, the second information indicates a data type by using a format, a long format indicates newly transmitted data, and a short format indicates retransmitted data.

Specifically, if the terminal device receives DCI for scheduling data, where a length of the DCI is in a long format, and an NDI in the DCI is toggled compared with an NDI in a long-format DCI received last time, the terminal device determines that the newly transmitted data is scheduled; or if the terminal device receives the DCI for scheduling the data, where the length of the DCI is in a short format, and the NDI in the DCI is not toggled compared with the NDI in the long-format DCI received last time, the terminal device determines that the retransmitted data is scheduled.

Data transmission in FIG. 7 to FIG. 10 is used as an example. A transport block (TB) is to-be-transmitted data. The terminal device receives a newly transmitted TB 1 at a moment t₀, where the scheduled DCI is in a long format, and NDI=0. The terminal device clears soft bit information in a previous buffer, and replaces the soft bit information with soft bit information decoded by the newly transmitted TB 1.

In FIG. 7, at a moment t₁, the terminal device receives a new scheduling, where NDI=0 in DCI, and the NDI is not toggled compared with an NDI of the newly transmitted TB 1; determines, based on the NDI, that the data is retransmitted data, and the scheduled DCI is in a short format; and determines, based on the format of the DCI, that the data is the retransmitted data; and the terminal device acknowledges, based on comprehensive determining, that the data in this scheduling is the retransmitted data of the newly transmitted TB 1 (a retransmitted TB 1), and performs soft combination on a decoding result of the data at the moment t₁ and the soft bit information in the buffer. At a moment t₂, the terminal device receives a new scheduling, where NDI=0 in the DCI, and the NDI is not toggled compared with an NDI of the retransmitted TB 1; determines, based on the NDI, that the data is retransmitted data, and the scheduled DCI is in a short format; and determines, based on the format of the DCI, that the data is the retransmitted data; and the terminal device acknowledges, based on comprehensive determining, that the data in this scheduling is the retransmitted data, and performs soft combination on a decoding result of the data at the moment t₂ and the soft bit information in the buffer.

In FIG. 8, at a moment t₁, the terminal device receives a new scheduling, where NDI=0 in DCI, and the NDI is not toggled compared with an NDI of the newly transmitted TB 1; determines, based on the NDI, that the data is retransmitted data, and the scheduled DCI is in a short format; and determines, based on the format of the DCI, that the data is the retransmitted data; and the terminal device acknowledges, based on comprehensive determining, that the data in this scheduling is the retransmitted data of the newly transmitted TB 1 (a retransmitted TB 1), and performs soft combination on a decoding result of the data at the moment t₁ and the soft bit information in the buffer. At a moment t₂, the terminal device receives a new scheduling, where NDI=1 in the DCI, and the NDI is toggled compared with an NDI of the retransmitted TB 1; determines, based on the NDI, that the data is newly transmitted data, and the scheduled DCI is in a long format; and determines, based on the format of the DCI, that the data is the newly transmitted data; and the terminal device acknowledges, based on comprehensive determining, that the data in this scheduling is the newly transmitted data (a newly transmitted TB 2), clears soft bit information in a previous buffer, and replaces the soft bit information with soft bit information of a decoding result of the data at the moment t₂.

In FIG. 9, at a moment t₁, the terminal device receives a new scheduling, where NDI=1 in DCI, and the NDI is toggled compared with an NDI of the newly transmitted TB 1; determines, based on the NDI, that the data is newly transmitted data, and the scheduled DCI is in a long format; and determines, based on the format of the DCI, that the data is the newly transmitted data; and the terminal device acknowledges, based on comprehensive determining, that the data in this scheduling is the newly transmitted data (a newly transmitted TB 2), clears soft bit information in a previous buffer, and replaces the soft bit information with soft bit information of a decoding result of the data at the moment t₁. At a moment t₂, the terminal device receives a new scheduling, where NDI=1 in the DCI, and the NDI is not toggled compared with an NDI of the newly transmitted TB 2; determines, based on the NDI, that the data is retransmitted data, and the scheduled DCI is in a short format; and determines, based on the format of the DCI, that the data is the retransmitted data; and the terminal device acknowledges, based on comprehensive determining, that the data in this scheduling is the retransmitted data of the newly transmitted TB 2 (a retransmitted TB 2), and performs soft combination on a decoding result of the data at the moment t₂ and the soft bit information in the buffer.

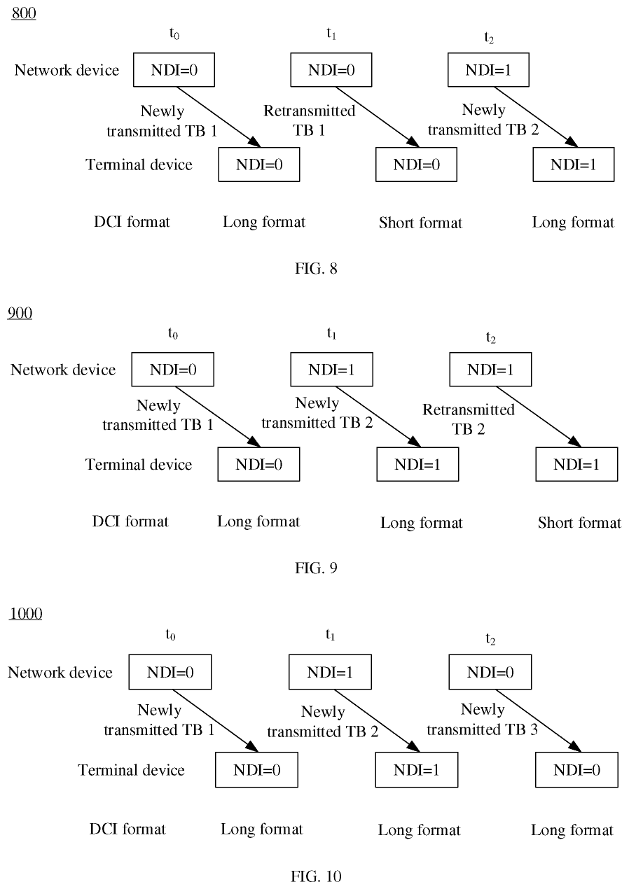

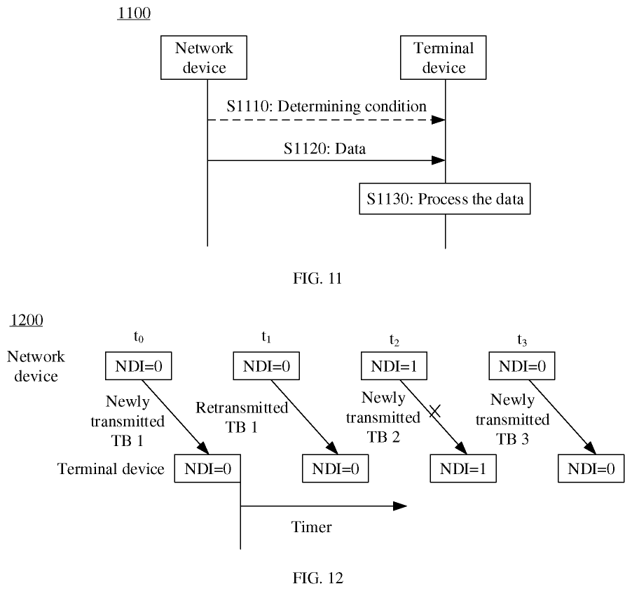

In FIG. 10, at a moment t₁, the terminal device receives a new scheduling, where NDI=1 in DCI, and the NDI is toggled compared with an NDI of the newly transmitted TB 1; determines, based on the NDI, that the data is newly transmitted data, and the scheduled DCI is in a long format; and determines, based on the format of the DCI, that the data is the newly transmitted data; and the terminal device acknowledges, based on comprehensive determining, that the data in this scheduling is the newly transmitted data (a newly transmitted TB 2), clears soft bit information in a previous buffer, and replaces the soft bit information with soft bit information of a decoding result of the data at the moment t₁. At a moment t₂, the terminal device receives a new scheduling, where NDI=0 in the DCI, and the NDI is toggled compared with an NDI of the newly transmitted TB 2; determines, based on the NDI, that the data is newly transmitted data, and the scheduled DCI is in a long format; and determines, based on the format of the DCI, that the data is the newly transmitted data; and the terminal device acknowledges, based on comprehensive determining, that the data in this scheduling is the newly transmitted data (a newly transmitted TB 3), clears soft bit information in a previous buffer, and replaces the soft bit information with soft bit information of a decoding result of the data at the moment t₂.

The solutions in embodiments of this disclosure may be applied to not only a scenario in which the terminal device normally receives data, but also a scenario in which the terminal device misses detection of data, to improve reliability and accuracy of data transmission. The data transmission scenarios in FIG. 7 to FIG. 10 are used as examples, and it is assumed that the terminal device misses detection of the data at the moment t₁.

In FIG. 7, the terminal device receives the new scheduling at the moment t₂, where NDI=0 in the DCI, and the NDI is not toggled compared with the NDI of the newly transmitted TB 1 at a moment t₀; determines, based on the NDI, that the data is the retransmitted data, and the scheduled DCI is in the short format; and determines, based on the format of the DCI, that the data is the retransmitted data; and the terminal device determines that the data at the moment t₂ is the retransmitted data of the newly transmitted TB 1, performs soft combination on the decoding result of the data at the moment t₂ and the soft bit information in the buffer, so that the terminal device can correctly determine the data type and correctly process the data after miss detection occurs.

In FIG. 8, the terminal device receives the new scheduling at the moment t₂, where NDI=1 in the DCI, and the NDI is toggled compared with the NDI of the newly transmitted TB 1 at a moment t₀; determines, based on the NDI, that the data is the newly transmitted data, and the scheduled DCI is in the long format; and determines, based on the format of the DCI, that the data is the newly transmitted data; and the terminal device determines that the data at the moment t₂ is the newly transmitted data (the newly transmitted TB 2), clears the soft bit information in the previous buffer, and replaces the soft bit information with the soft bit information of the decoding result of the data at the moment t₂, so that the terminal device can correctly determine the data type and correctly process the data after miss detection occurs.

In FIG. 9, the terminal device receives the new scheduling at the moment t₂, where NDI=1 in the DCI, and the NDI is toggled compared with the NDI of the newly transmitted TB 1 at a moment t₀; determines, based on the NDI, that the data is the newly transmitted data, and the scheduled DCI is in the short format; and determines, based on the format of the DCI, that the data is the retransmitted data. Because the terminal device determines a conflict between the NDI and a result of determining based on the format of the DCI, the terminal device determines that miss detection occurs. Because the scheduled DCI is in the short format at the moment t₂, the data at the moment t₂ is retransmitted data of data that misses to be detected. In this case, a value of an NDI of the data that misses to be detected is 1, the NDI is toggled compared with the NDI of the newly transmitted TB 1 at the moment t₀, and the data that misses to be detected is the newly transmitted data (the newly transmitted TB 2). Because the data at the moment t₂ is the retransmitted data of the newly transmitted TB 2, and the data is new data in comparison with the newly transmitted TB 1, the terminal device cannot perform soft combination on the decoding result of the data at the moment t₂ and the soft bit information in the buffer, and the terminal device clears the soft bit information in the previous buffer, and replaces the soft bit information with the soft bit information of the decoding result of the data at the moment t₂.

If the terminal device performs determining only based on the format of the DCI, the terminal device determines that the data at the moment t₂ is the retransmitted data of the newly transmitted TB 1, and performs soft combination on the decoding result of the data at the moment t₂ and the soft bit information in the buffer. Consequently, an error occurs in data decoding, and reliability of data transmission is affected.

In FIG. 10, the terminal device receives the new scheduling at the moment t₂, where NDI=0 in the DCI, and the NDI is not toggled compared with the NDI of the newly transmitted TB 1 at a moment t₀; determines, based on the NDI, that the data is the retransmitted data, and the scheduled DCI is in the long format; and determines, based on the format of the DCI, that the data is the newly transmitted data. Because the terminal device determines a conflict between the NDI and a result of determining based on the format of the DCI, the terminal device determines that miss detection occurs. Because the scheduled DCI at the moment t₂ is in the long format, the data at the moment t₂ is newly transmitted data of data that misses to be detected. In this case, a value of an NDI of the data that misses to be detected is 1, the NDI is toggled compared with the NDI of the newly transmitted TB 1 at the moment t₀, and the data that misses to be detected is the newly transmitted data. Therefore, the terminal device determines that the data at the moment t₂ is the newly transmitted data and the terminal device misses detection of a previous piece of newly transmitted data, and the terminal device clears the soft bit information in the previous buffer, and replaces the soft bit information with the soft bit information of the decoding result of the data at the moment t₂.

If the terminal device determines, only based on the NDI, the data received at the moment t₂, the value of the NDI is shown in Table 5.

TABLE 5

| Time | NDI |
|---|---|
| t₀ | 0 |
| t₁ | 1 |
| t₂ | 0 |

Because the terminal device misses detection of the data at the moment t₁, the terminal device compares the NDI received at the moment t₂ with the NDI received at the moment t₀, determines that the NDI is not toggled, determines that the data at the moment t₂ is the retransmitted data of the data at the moment t₀, and performs soft combination on the decoding result of the data at the moment t₂ and the soft bit information in the buffer. However, actually, the NDI at the moment t₂ is toggled compared with the NDI at the moment t₁, and the data at the moment t₂ is the newly transmitted data. Therefore, the terminal device incorrectly determines the data and incorrectly processes the data. As a result, an error occurs in data decoding, and reliability of data transmission is affected.

Based on the foregoing descriptions, regardless of whether miss detection occurs on the terminal device, the method provided in this embodiment of this disclosure may be that the terminal device correctly processes the data, thereby improving reliability of data transmission.

In a possible implementation, the second information includes an LNDI, and a value of the LNDI is the same as a value of an NDI in DCI of data sent by the network device last time. If the value of the LNDI is different from the value of the NDI in the DCI received by the terminal device last time, the terminal device determines that there is data that misses to be detected. In addition, because the value of the LNDI is different from the value of the NDI in the DCI received by the terminal device last time, the terminal device further determines that the data that misses to be detected is newly transmitted data. Further, if the value of the LNDI is the same as the value of the NDI in the DCI received by the terminal device this time, the terminal device determines that the data received this time is retransmitted data of the data that misses to be detected, and the terminal device clears the soft bit information in the previous buffer, and replaces the soft bit information with soft bit information of a decoding result of the data received this time. If the value of the LNDI is different from the value of the NDI in the DCI received by the terminal device this time, the terminal device determines that the data received this time is newly transmitted data of the data that misses to be detected, and the terminal device clears the soft bit information in the previous buffer, and replaces the soft bit information with the soft bit information of the decoding result of the data received this time. To be specific, the terminal device determines that the value of the LNDI is different from the value of the NDI in the DCI received by the terminal device last time, and the terminal device clears the soft bit information in the previous buffer, and replaces the soft bit information with the soft bit information of the decoding result of the data received this time. If the value of the LNDI is the same as the value of the NDI in the DCI received by the terminal device last time, the terminal device compares the LNDI with the NDI in the DCI received by the terminal device this time. If the value of the LNDI is the same as the value of the NDI in the DCI received by the terminal device this time, the terminal device determines that the data received this time is retransmitted data, and the terminal device performs soft combination on the decoding result of the data received this time and the soft bit information in the buffer. If the value of the LNDI is different from the value of the NDI in the DCI received by the terminal device this time, the terminal device determines that the data received this time is newly transmitted data, and the terminal device clears the soft bit information in the previous buffer, and replaces the soft bit information with the soft bit information of the decoding result of the data received this time.

It should be understood that the LNDI may indicate that the data is newly transmitted data or retransmitted data. However, the LNDI cannot separately indicate that the data is the newly transmitted data or the retransmitted data, and needs to be used together with the NDI to indicate that the data is the newly transmitted data or the retransmitted data.

If the terminal device determines, based on only the NDI, that the data is the newly transmitted data or the retransmitted data, and performs corresponding processing on the data, incorrect determining may be caused due to missing detection of the data. For details, refer to Table 4 or Table 5 and related descriptions thereof. However, based on the foregoing descriptions, regardless of whether miss detection occurs on the terminal device, the method provided in this embodiment of this disclosure may be that the terminal device correctly processes the data, thereby improving reliability of data transmission.

In a possible implementation, the second information includes the CNDI, and the terminal device may determine the LNDI based on the NDI and the CNDI. Based on the foregoing descriptions of the possible implementation of the LNDI, the terminal device may determine whether the data is the newly transmitted data or the retransmitted data.

It should be noted that in this embodiment of this disclosure, a process corresponding to a TB received by the terminal device is HARQ disable, which may be a result configured in the following cases: If only an RRC bitmap is configured, the process is configured as disable; if no RRC bitmap is configured, a HARQ-ACK resource field in the DCI indicates “1111”; or if an RRC bitmap is configured as enable, the HARQ-ACK resource field in the DCI indicates “1111”.

In this embodiment of this disclosure, a manner in which the first information and the second information in the control information are combined to indicate whether the data is the newly transmitted data or the retransmitted data, so that in addition to determining whether the data is the retransmitted data or the newly transmitted data, the terminal device can further determine whether miss detection occurs on the terminal device and a relationship between the data and the data that misses to be detected, and the terminal device processes the data more accurately, thereby improving reliability of data transmission. An existing field may be used for the first information and the second information, and no new field needs to be added. This not only reduces signaling, but also does not increase complexity of blind detection performed by the terminal device, thereby ensuring link reliability.

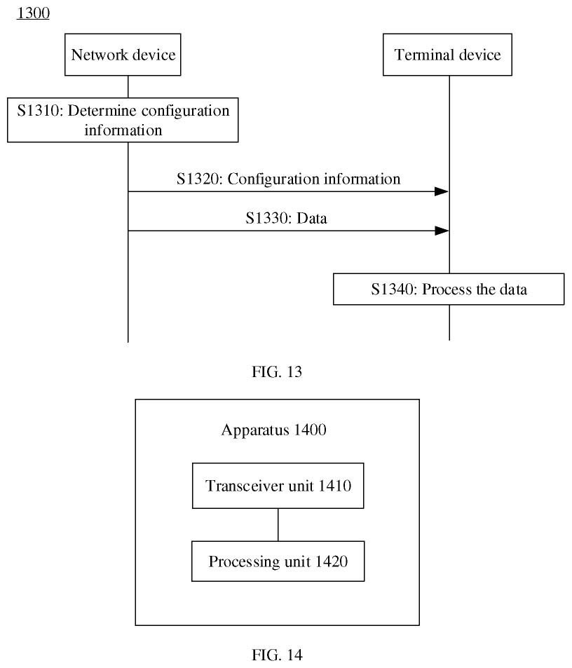

The communication method 200 is a method for processing the data sent by the network device to the terminal device. This disclosure further provides the method for processing the data sent by the network device to the terminal device. FIG. 11 is a diagram of a communication method 1100 according to an embodiment of this disclosure.

Optionally, in S1110, a network device configures a determining condition for a terminal device, where the determining condition includes a maximum quantity of blind retransmissions and/or a blind retransmission timer.

Because a quantity of repetitions in an IoT system is large, and data transmission time is long, if miss detection occurs on the terminal device, an interval from transmitted data that can be received last time is large in time domain. Therefore, a timer may be used to limit the newly transmitted data/the retransmitted data. In addition, the newly transmitted data/the retransmitted data may alternatively be limited by configuring a possible maximum quantity of retransmissions as a condition.

In a possible implementation, the determining condition may be determined based on capability information of the terminal device that is previously sent by the terminal device to the network device. The capability information of the terminal device indicates a data combination capability of the terminal device. The capability information may include at least one of the following: whether data combination is supported, a quantity of times that a buffer in the terminal device supports combination, and time for storing the data in the buffer in the terminal device.

In a possible implementation, the determining condition may be determined by the network device based on link quality of a cell in which the terminal device is located.

It should be noted that the foregoing determining manner of the determining condition is merely an example. How to determine the determining condition is not limited in this embodiment of this disclosure. For example, the determining condition may alternatively be preconfigured by the network device.

It should be noted that the determining condition is preconfigured in the terminal device, and in this case, the determining condition does not need to be sent to the terminal device by the network device.

In addition, in this disclosure, the terminal device and the network device may perform blind data retransmission in a scenario in which HARQ feedback is disabled.

In a possible implementation, the network device configures a process corresponding to data received by the terminal device as HARQ disable. For example, if only an RRC bitmap is configured, the process is configured as disable; if no RRC bitmap is configured, a HARQ-ACK resource field in the DCI indicates “1111”; or if an RRC bitmap is configured as enable, a HARQ-ACK resource field in the DCI indicates “1111”.

In a possible implementation, the terminal device is preconfigured as HARQ disable.

S1120: The network device sends the data to the terminal device.

S1130: The terminal device processes, based on the determining condition, the data sent by the network device to the terminal device. For newly transmitted data, the terminal device stores the newly transmitted data in a buffer; and for retransmitted data, the terminal device needs to perform further determining based on the determining condition.

The terminal device may determine that data received after the timer expires is the newly transmitted data, and does not combine the data.

Specifically, in a possible implementation, if the terminal device receives DCI for scheduling data, where an NDI in the DCI is toggled compared with an NDI in DCI of a same process that is received last time, the terminal device determines that the newly transmitted data is scheduled and starts the timer; or if the terminal device receives the DCI for scheduling data, where the NDI in the DCI is not toggled compared with the NDI in the DCI of the same process that is received last time, the terminal device determines that the retransmitted data is scheduled within a validity period of the timer, and after the timer expires, the terminal device determines that the newly transmitted data is scheduled, and does not combine the data.

For example, FIG. 12 is a diagram of data transmission 1200 according to an embodiment of this disclosure. A terminal device receives a first TB 1 at a moment t₀, and the TB 1 carries newly transmitted data. The terminal device receives a data scheduling as a scheduling of newly transmitted data, and starts a timer. At a moment t₁, the terminal device receives a new scheduling, and an NDI in DCI is not toggled. The terminal device determines that the new scheduling is scheduling of retransmitted data of scheduled data last time. At a moment t₃, the NDI in the DCI received by the terminal device is still not toggled. However, because the timer expires, the terminal device considers that this scheduling is a scheduling of the newly transmitted data, and does not perform soft combination on a current decoding result and a previous decoding result.

The terminal device may determine that data received after a maximum quantity of blind retransmissions is exceeded is the newly transmitted data, and do not combine the data.

In a possible implementation, if the terminal device receives DCI for scheduling data, where an NDI in the DCI is not toggled compared with an NDI in DCI of a same process that is received last time, and a maximum quantity of blind retransmissions is not exceeded, the terminal device determines that the retransmitted data is scheduled; or if the maximum quantity of blind retransmissions is exceeded, the terminal device determines that the newly transmitted data is scheduled, and does not perform combination. For example, a counter is disposed in the terminal device. The counter is reset to zero when the terminal device receives the newly transmitted data, and is accumulated when the terminal device receives the retransmitted data.

Based on the foregoing solution, it may be ensured that a quantity of pieces of duplicate data and duration of the duplicate data are within a combination capability range of the terminal device, thereby improving reliability of data transmission. In addition, complexity of processing the data by the terminal device can be reduced, and efficiency of data transmission can be improved.

It should be noted that in the foregoing method 1100, the terminal device performs determining based on the quantity of retransmissions and the retransmission time. The determining process may be completed by the network device. A maximum quantity of blind retransmissions and/or a blind retransmission timer are set in the network device. When scheduling retransmission expires or retransmitted data whose quantity exceeds a maximum quantity of blind retransmissions is retransmitted, the network device may change DCI corresponding to the retransmitted data to indicate the newly transmitted data.

It should be noted that the method 1100 and the method 200 are used in combination. For example, after determining, based on a joint indication of the first information and the second information, that the first data is retransmitted data, the terminal device further determines the first data based on the maximum quantity of blind retransmissions and/or the blind retransmission timer in the method 1100, and then processes the first data.

It should be understood that the communication methods 200 and 1100 may be applied to the blind retransmission scheduling, and a problem caused by missing detection of data by the terminal device during the blind retransmission scheduling is resolved. In this disclosure, the network device may further configure, for the terminal device, whether to support the blind retransmission scheduling. FIG. 13 is a diagram of a communication method 1300 according to an embodiment of this disclosure.

S1310: A network device determines configuration information, where the configuration information is used to configure whether a terminal device supports a blind retransmission scheduling.

In a possible implementation, the network device receives capability information reported by the terminal device, where the capability information indicates a data combination capability of the terminal device. Specifically, the data combination capability of the terminal device includes a soft combination capability of the terminal device when HARQ feedback is disabled. The network device configures, based on the capability information, whether to perform the blind retransmission scheduling.

For example, the capability information includes whether the terminal device supports soft combination when HARQ feedback is disabled, and the capability information may further include a quantity of times that a buffer in the terminal device supports combination and/or time for storing data in the buffer in the terminal device.

In a possible implementation, the network device determines the configuration information based on link quality of a cell in which the terminal device is located. For example, in a time period in which data transmission occurs, the cell in which the terminal device is located is located in an open area, and is not easily interfered by weather or the like, and the link quality is stable. The network device configures the terminal device to not support the blind retransmission scheduling. The link quality may be determined by the network device based on a communication feedback of another device that is located in a same cell as the terminal device.

In a possible implementation, the network device determines, based on a status parameter of the device, a quantity of repetitions required for data transmission, to determine whether to configure the terminal device to support the blind retransmission scheduling. For example, the status parameter may include an elevation angle, a satellite location, a satellite moving speed, a location of the terminal device, a moving speed of the terminal device, or the like.

In this embodiment of this disclosure, if the terminal device supports soft combination when the HARQ feedback is disabled, the configuration information is used to configure the terminal device to support the blind retransmission scheduling. The configuration information may further include a maximum quantity of pieces of retransmitted data corresponding to same data and/or a maximum time interval of retransmitted data corresponding to same data. For example, if the maximum quantity of pieces of retransmitted data corresponding to the same data is N, the network device sends a maximum of N pieces of retransmitted data corresponding to the same data; or if the maximum time interval of the retransmitted data corresponding to the same data is M, a maximum time interval between sending the retransmitted data by the network device and sending corresponding newly transmitted data is M.

S1320: The network device sends the configuration information to the terminal device.

For example, the network device sends the configuration information to the terminal device by using RRC signaling or a media access control control element (MAC CE) message.

Specifically, when the blind retransmission is enabled, it indicates that the network device may perform the blind retransmission scheduling in a subsequent scheduling. However, when the signaling is not configured or the signaling is configured as disable, it indicates that the network device does not perform the blind retransmission scheduling, and transmission of all data is scheduling of the newly transmitted data.

S1330: The network device sends the data to the terminal device.

S1340: The terminal device processes the data from the network device based on the configuration information.

Specifically, if the network device configures that the terminal device does not support the blind retransmission scheduling, the terminal device clears the data in the buffer, and stores new data. If the network device configures that the terminal device supports the blind retransmission scheduling, the terminal device needs to determine whether the data is newly transmitted data or retransmitted data. Correspondingly, the terminal device clears the data in the buffer, and stores the newly transmitted data or combines the retransmitted data into the data in the buffer.

In a possible implementation, the terminal device determines, by using the method in the method 200, whether the data is the newly transmitted data or the retransmitted data. For details, refer to related descriptions in FIG. 2.

In a possible implementation, the terminal device is configured with a maximum quantity of blind retransmissions and/or a blind retransmission timer. When a quantity of retransmissions of data received by the terminal device exceeds a maximum quantity of times, or the blind retransmission timer exceeds maximum duration of blind retransmission, even if an NDI of the terminal device is not toggled, the terminal device determines that the data is newly transmitted data, and does not combine current data and previous data. A manner of determining the maximum quantity of blind retransmissions and the maximum duration of the blind retransmission is not limited in this embodiment of this disclosure. For example, the maximum quantity of blind retransmissions and the maximum duration of the blind retransmission may be preset in the terminal device, or the network device configures the maximum quantity of blind retransmissions and the maximum duration of the blind retransmission for the terminal device based on capability information of the terminal device, or the network device configures the maximum quantity of blind retransmissions and the maximum duration of the blind retransmission for the terminal device based on link quality of a cell in which the terminal device is located.

In the foregoing solution, the network device configures whether the terminal device supports blind retransmission scheduling, so that capabilities of different terminal devices can be distinguished, thereby ensuring link reliability.

It should be noted that the method 1300 may be used in combination with the method 200 or the method 1100. After the terminal device is configured to support blind retransmission scheduling by using the method 1300, the method 200 or the method 1100 is used to process the data sent by the network device to the terminal device. For specific descriptions, refer to the descriptions of the method 200, the method 1100, and the method 1300.

It should be noted that the method 1300 is an example of configuring whether the terminal device supports blind retransmission. A manner of configuring whether the terminal device supports blind retransmission is not limited in this disclosure. For example, whether to support blind retransmission may be preconfigured in the terminal device. A maximum quantity of blind retransmissions and/or a blind retransmission timer may be protocol-pre-specified, and the maximum quantity of blind retransmissions and/or the blind retransmission timer are/is preconfigured in the terminal device.

The foregoing describes the method embodiments in embodiments of this disclosure with reference to the accompanying drawings, and the following describes apparatus embodiments in embodiments of this disclosure. It may be understood that the descriptions of the method embodiments and the descriptions of the apparatus embodiments may correspond to each other. Therefore, for a part that is not described, refer to the foregoing method embodiments.

It may be understood that in the foregoing method embodiments, the methods and operations implemented by the terminal device may alternatively be implemented by a component (for example, a chip or a circuit) that may be used in the terminal device, and the methods and operations implemented by the network device may alternatively be implemented by a component (for example, a chip or a circuit) that may be used in the network device.

The foregoing mainly describes the solutions provided in embodiments of this disclosure from a perspective of interaction between network elements. It may be understood that, to implement the foregoing functions, each network element such as a transmitter device or a receiver device includes a corresponding hardware structure and/or software module for performing each function. A person skilled in the art may be aware that, with reference to the examples described in embodiments disclosed in this specification, units and algorithm steps can be implemented by hardware or a combination of computer software and hardware in this disclosure. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this disclosure.

In embodiments of this disclosure, functional modules of a transmitter device or a receiver device may be obtained through division based on the foregoing method examples. For example, each functional module may be obtained through division based on each function, or two or more functions may be integrated into one processing module. The integrated module may be implemented in a form of hardware, or may be implemented in a form of a software functional module. It should be noted that in embodiments of this disclosure, division into modules is an example, and is merely a logical function division. During actual implementation, another division manner may be used. An example in which each functional module is obtained through division based on each corresponding function is used below for description.

FIG. 14 is a diagram of a structure of a communication apparatus according to an embodiment of this disclosure.

The apparatus 1400 includes a transceiver unit 1410 and a processing unit 1420. The transceiver unit 1410 may be configured to implement a corresponding communication function, and the processing unit 1420 may be configured to perform data processing.

Optionally, the transceiver unit 1410 may also be referred to as a communication interface or a communication unit, and includes a sending unit and/or a receiving unit. The transceiver unit 1410 may be a transceiver (including a transmitter and/or a receiver), an input/output interface (including an input interface and/or an output interface), a pin, a circuit, or the like. The transceiver unit 1410 may be configured to perform a sending step and/or a receiving step in the foregoing method embodiments.

Optionally, the processing unit 1420 may be a processor (may include one or more processors), a processing circuit having a processor function, or the like, and may be configured to perform a step other than sending and receiving in the foregoing method embodiments.

Optionally, the apparatus 1400 further includes a storage unit. The storage unit may be a memory, an internal storage unit (for example, a register or a cache), an external storage unit (for example, a read-only memory or a random access memory), or the like. The storage unit is configured to store instructions. The processing unit 1420 executes the instructions stored in the storage unit, so that the communication apparatus performs the foregoing method.

In a design, the apparatus 1400 may correspond to the terminal device in the foregoing method embodiments, or a component (for example, a chip) of the terminal device.

The apparatus 1400 may implement corresponding steps or procedures performed by the terminal device in the foregoing method embodiments. The transceiver unit 1410 may be configured to perform receiving and sending related operations of the terminal device in the foregoing method embodiments. The processing unit 1420 may be configured to perform a processing related operation of the terminal device in the foregoing method embodiments.

In a possible implementation, the transceiver unit 1410 is configured to receive first control information and first data from a network device, where the first control information is used to schedule the first data, the first control information includes second information and first information, the second information and the first information indicate that the first data is newly transmitted data or retransmitted data, and indication manners of the second information and the first information are different. The processing unit 1420 is configured to process the first data based on the first control information.

In another possible implementation, the transceiver unit 1410 is configured to receive configuration information from a network device, where the configuration information is used to configure whether to perform blind retransmission. The processing unit 1420 is configured to process, based on the configuration information, data sent by the network device.

When the apparatus 1400 is configured to perform the methods in FIG. 2 to FIG. 13, the transceiver unit 1410 may be configured to perform the steps of receiving and sending information in the methods, and the processing unit 1420 may be configured to perform the processing step in the methods.

In another possible implementation, the transceiver unit 1410 is configured to receive the data sent by the network device. The processing unit 1420 is configured to: determine that the data sent by the network device is newly transmitted data, store the newly transmitted data, reset a counter to zero, and start the counter, where the counter is used to count a quantity of pieces of retransmitted data; determine that the data sent by the network device is retransmitted data and a value indicated by the counter is less than or equal to a threshold, perform data combination on the retransmitted data, and increase the value indicated by the counter by 1; or determine that the data sent by the network device is the retransmitted data and the value indicated by the counter is greater than the threshold, store the retransmitted data, and clear the counter.

In another possible implementation, the transceiver unit 1410 is configured to receive the data sent by the network device. The processing unit 1420 is configured to: determine that the data sent by the network device is newly transmitted data, store the newly transmitted data, reset a counter to zero, and start the counter, where the counter is used to count a quantity of pieces of retransmitted data; and determine that the data sent by the network device is retransmitted data and a value indicated by the counter is less than or equal to a threshold, and perform data combination on the retransmitted data; or determine that the data sent by the network device is the retransmitted data and the value indicated by the counter is greater than the threshold, store the retransmitted data, and clear the counter.

It should be understood that a specific process in which the units perform the foregoing corresponding steps is described in detail in the foregoing method embodiments. For brevity, details are not described herein.

In another design, the apparatus 1400 may correspond to the network device in the foregoing method embodiments, or may be a component (for example, a chip) of the network device.

In a possible implementation, the processing unit 1420 is configured to determine first control information based on first data. The transceiver unit 1410 is configured to send the first control information and the first data to a terminal device, where the first control information is used to schedule the first data, the first control information includes second information and first information, the second information and the first information indicate that the first data is newly transmitted data or retransmitted data, and indication manners of the second information and the first information are different.

In another possible implementation, the processing unit 1420 is configured to determine configuration information, where the configuration information is used to configure whether to perform blind retransmission. The transceiver unit 1410 is configured to send the configuration information to the terminal device.

When the apparatus 1400 is configured to perform the methods in FIG. 2 to FIG. 13, the transceiver unit 1410 may be configured to perform the steps of receiving and sending information in the methods, and the processing unit 1420 may be configured to perform the processing step in the methods.

It should be understood that a specific process in which the units perform the foregoing corresponding steps is described in detail in the foregoing method embodiments. For brevity, details are not described herein.

It should be understood that the apparatus 1400 herein is embodied in a form of a functional unit. The term “unit” herein may be an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that the apparatus 1400 may be the network device in the foregoing embodiments, and may be configured to perform procedures and/or steps corresponding to the network device in the foregoing method embodiments. To avoid repetition, details are not described herein again.

The apparatus 1400 in the foregoing solutions has a function of performing corresponding steps performed by devices (for example, the terminal device and the network device) in the foregoing methods. The function may be implemented by hardware, or may be implemented by hardware executing corresponding software. The hardware or the software includes one or more modules corresponding to the foregoing function. For example, the transceiver unit may be replaced with a transceiver (for example, a sending unit in the transceiver unit may be replaced with a transmitter, and a receiving unit in the transceiver unit may be replaced with a receiver), and another unit such as a processing unit may be replaced with a processor, to separately perform receiving and sending operations and a related processing operation in method embodiments.

In addition, the transceiver unit 1410 may alternatively be a transceiver circuit (for example, the transceiver circuit may include a receiving circuit and a sending circuit), and the processing unit may be a processing circuit.

It should be noted that the apparatus in FIG. 14 may be a network element or a device in the foregoing embodiments, or may be a chip or a chip system, for example, a system on chip (SoC). The transceiver unit may be an input/output circuit or a communication interface. The processing unit is a processor, a microprocessor, or an integrated circuit integrated on the chip. This is not limited herein.

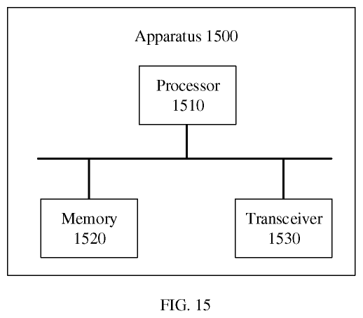

FIG. 15 is a diagram of a structure of a communication apparatus 1500 according to an embodiment of this disclosure. The communication apparatus 1500 shown in FIG. 15 includes a processor 1510, a memory 1520, and a transceiver 1530. The processor 1510 is coupled to the memory 1520, and is configured to execute instructions stored in the memory 1520, to control the transceiver 1530 to send a signal and/or receive a signal.

It should be understood that the processor 1510 and the memory 1520 may be integrated into one processing apparatus. The processor 1510 is configured to execute program code stored in the memory 1520 to implement the foregoing functions. During specific implementation, the memory 1520 may alternatively be integrated into the processor 1510, or may be independent of the processor 1510. It should be understood that the processor 1510 may alternatively correspond to each processing unit in the foregoing communication apparatus, and the transceiver 1530 may correspond to each receiving unit and each sending unit in the foregoing communication apparatus.

It should be further understood that the transceiver 1530 may include a receiver (which is also referred to as a receiver machine) and a transmitter (which is also referred to as a transmitter machine). The transceiver may further include an antenna, and there may be one or more antennas. The transceiver may alternatively be a communication interface or an interface circuit.

Specifically, the communication apparatus 1500 may correspond to the device (the terminal device or the network device) in FIG. 2 to FIG. 13 according to embodiments of this disclosure. The communication apparatus 1500 may include units of the method performed by the terminal device in FIG. 2 to FIG. 13, or units of the method performed by the network device. It should be understood that a specific process in which the units perform the foregoing corresponding steps is described in detail in the foregoing method embodiments. For brevity, details are not described herein.

When the communication apparatus 1500 is a chip, the chip includes an interface unit and a processing unit. The interface unit may be an input/output circuit or a communication interface. The processing unit may be a processor, a microprocessor, or an integrated circuit integrated on the chip.

In an implementation process, steps in the foregoing methods can be implemented through a hardware integrated logic circuit in the processor, or by using instructions in a form of software. The steps of the method disclosed with reference to embodiments of this disclosure may be directly performed and completed by a hardware processor, or may be performed and completed by using a combination of hardware in the processor and a software module. The software module may be located in a storage medium in the art, such as a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor. To avoid repetition, details are not described herein again. It should be noted that the processor in embodiments of this disclosure may be an integrated circuit chip, and has a signal processing capability. In an implementation process, steps in the foregoing method embodiments can be implemented through a hardware integrated logic circuit in the processor, or by using instructions in a form of software. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or perform the methods, the steps, and logical block diagrams that are disclosed in embodiments of this disclosure. The general-purpose processor may be a microprocessor, or the processor may be any conventional processor or the like. The steps in the methods disclosed with reference to embodiments of this disclosure may be directly performed and completed by a hardware decoding processor, or may be performed and completed by using a combination of hardware in the decoding processor and a software module. The software module may be located in a storage medium in the art, such as a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor.

This disclosure further provides a communication system. The communication system includes a terminal device and a network device. The terminal device performs an action of the terminal device in any one of the foregoing methods, and the network device performs an action of the network device in any one of the foregoing methods.

This disclosure further provides a computer-readable medium. The computer-readable medium stores a computer program. When the computer program is executed by a computer, functions of any one of the foregoing method embodiments are implemented.

This disclosure further provides a computer program product. When the computer program product is executed by a computer, functions of any one of the foregoing method embodiments are implemented.

All or some of the foregoing embodiments may be implemented by software, hardware, firmware, or any combination thereof. When the software is used to implement embodiments, all or some of embodiments may be implemented in a form of a computer program product. The computer program product includes one or more computer instructions. When the computer instructions are loaded and executed on a computer, the procedure or functions according to embodiments of this disclosure are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid state disk (SSD)), or the like.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this disclosure, it should be understood that the disclosed system, apparatus, and method may be implemented in other manners. For example, the foregoing apparatus embodiments are merely examples. For example, division into the units is merely logical function division. During actual implementation, another division manner may be used. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one place, or may be distributed on a plurality of network units. Some or all of the units may be selected based on actual requirements to achieve the objectives of the solutions of embodiments.

In addition, functional units in embodiments of this disclosure may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this disclosure essentially, or the part contributing to the conventional technology, or some of the technical solutions may be implemented in a form of a software product. The computer software product is stored in a storage medium, and includes several instructions for indicating a computer device (which may be a personal computer, a server, a network device, or the like) to perform all or some of the steps of the method described in embodiments of this disclosure. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

Terminologies such as “component”, “module”, and “system” used in this specification indicate computer-related entities, hardware, firmware, combinations of hardware and software, software, or software being executed. For example, a component may be, but is not limited to, a process that runs on a processor, a processor, an object, an executable file, an execution thread, a program, and/or a computer. As illustrated by using figures, both a computing device and an application that runs on the compute device may be components. One or more components may reside within a process and/or a thread of execution, and a component may be located on one computer and/or distributed between two or more computers. In addition, these components may be executed from various computer-readable media that store various data structures. For example, the components may communicate by using a local and/or remote process and based on, for example, a signal having one or more data packets (for example, data from two components interacting with another component in a local system, a distributed system, and/or across a network such as the internet interacting with another system by using the signal).

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this disclosure.

What is claimed is:

1. A communication method, comprising:
receiving first control information and first data from a network device, wherein the first control information enables scheduling the first data, the first control information comprises first information and second information, the first information and the second information each indicate whether the first data is newly transmitted data or retransmitted data, and indication schemes of the first information and the second information are different; and
processing the first data based on the first information and the second information of the first control information.

2. The method according to claim 1, wherein processing the first data based on the first information and the second information of the first control information comprises:
determining, based on the first information and the second information of the first control information, whether the first data is retransmitted data or newly transmitted data.

3. The method according to claim 1, wherein
when the first data is newly transmitted data, a value carried in the first information in the first control information is different from a value carried in the first information in second control information, wherein the second control information enables scheduling second data, and the second data is data sent by the network device before the first data; and
when the first data is retransmitted data, the value carried in the first information in the first control information is the same as the value carried in the first information in the second control information; or
when the first data is newly transmitted data, the value carried in the first information in the first control information is the same as the value carried in the first information in the second control information; and
when the first data is retransmitted data, the value carried in the first information in the first control information is different from the value carried in the first information in the second control information.

4. The method according to claim 1, wherein the second information comprises a first value or a second value, the first value indicates newly transmitted data, and the second value indicates retransmitted data.

5. The method according to claim 1, wherein
when the first data is newly transmitted data, the second information in the first control information comprises a first field; and
when the first data is retransmitted data, the second information in the first control information does not comprise the first field; or
when the first data is newly transmitted data, the second information in the first control information does not comprise the first field; and
when the first data is retransmitted data, the second information in the first control information comprises the first field.

6. The method according to claim 3, wherein the second information indicates a value carried in the first information in the second control information.

7. The method according to claim 1, wherein the method further comprises:
receiving configuration information from the network device, wherein the configuration information enables configuring receiving of retransmitted data.

8. A communication apparatus comprising:
a transceiver; and
at least one processor coupled to one or more memories storing programming instructions for execution by the at least one processor to cause the communication apparatus to perform operations comprising:
receiving first control information and first data from a network device, wherein the first control information enables scheduling the first data, the first control information comprises first information and second information, the first information and the second information each indicate whether the first data is newly transmitted data or retransmitted data, and indication schemes of the first information and the second information are different; and
processing the first data based on the first information and the second information of the first control information.

9. The communication apparatus according to claim 8, wherein the operations further comprise:
determining, based on the first information and the second information of the first control information, whether the first data is retransmitted data or newly transmitted data.

10. The communication apparatus according to claim 8, wherein
when the first data is newly transmitted data, a value carried in the first information in the first control information is different from a value carried in the first information in second control information, wherein the second control information enables scheduling second data, and the second data is data sent by the network device before the first data; and
when the first data is retransmitted data, the value carried in the first information in the first control information is the same as the value carried in the first information in the second control information; or
when the first data is newly transmitted data, the value carried in the first information in the first control information is the same as the value carried in the first information in the second control information; and
when the first data is retransmitted data, the value carried in the first information in the first control information is different from the value carried in the first information in the second control information.

11. The communication apparatus according to claim 8, wherein the second information comprises a first value or a second value, the first value indicates newly transmitted data, and the second value indicates retransmitted data.

12. The communication apparatus according to claim 8, wherein
when the first data is newly transmitted data, the second information in the first control information comprises a first field; and
when the first data is retransmitted data, the second information in the first control information does not comprise the first field; or
when the first data is newly transmitted data, the second information in the first control information does not comprise the first field; and
when the first data is retransmitted data, the second information in the first control information comprises the first field.

13. The communication apparatus according to claim 10, wherein the second information indicates a value carried in the first information in the second control information.

14. The communication apparatus according to claim 8, wherein the operations further comprise:
receiving configuration information from the network device, wherein the configuration information enables configuring receiving of retransmitted data.

15. A non-transitory computer-readable storage medium storing computer instructions that, when executed by a communication apparatus, cause the communication apparatus to perform operations comprising:
receiving first control information and first data from a network device, wherein the first control information enables scheduling the first data, the first control information comprises first information and second information, the first information and the second information each indicate whether the first data is newly transmitted data or retransmitted data, and indication schemes of the first information and the second information are different; and
processing the first data based on the first information and the second information of the first control information.

16. The non-transitory computer-readable storage medium according to claim 15, wherein the operations further include:
determining, based on the first information and the second information of the first control information, whether the first data is retransmitted data or newly transmitted data.

17. The non-transitory computer-readable storage medium according to claim 15, wherein
when the first data is newly transmitted data, a value carried in the first information in the first control information is different from a value carried in the first information in second control information, wherein the second control information enables scheduling second data, and the second data is data sent by the network device before the first data; and
when the first data is retransmitted data, the value carried in the first information in the first control information is the same as the value carried in the first information in the second control information; or
when the first data is newly transmitted data, the value carried in the first information in the first control information is the same as the value carried in the first information in the second control information; and
when the first data is retransmitted data, the value carried in the first information in the first control information is different from the value carried in the first information in the second control information.

18. The non-transitory computer-readable storage medium according to claim 15, wherein the second information comprises a first value or a second value, the first value indicates newly transmitted data, and the second value indicates retransmitted data.

19. The non-transitory computer-readable storage medium according to claim 15, wherein
when the first data is newly transmitted data, the second information in the first control information comprises a first field; and
when the first data is retransmitted data, the second information in the first control information does not comprise the first field; or
when the first data is newly transmitted data, the second information in the first control information does not comprise the first field; and
when the first data is retransmitted data, the second information in the first control information comprises the first field.

20. The non-transitory computer-readable storage medium according to claim 17, wherein the second information indicates a value carried in the first information in the second control information.
